(19) United States
(12) Patent Application Publication
(10) Pub. No.: US 2011/0257016 A1
(43) Pub. Date: Oct. 20, 2011

(54) Gel Formulations that are Stable for Storage, Comprising at Least Two Substantially Unmixed Hydrogels

(75) Inventors: Christian Sowa, Neustadt (DE); Marcus Annawald, Schifferstadt (DE)

(73) Assignee: BASF SE, Ludwigshafen (DE)

(21) Appl. No.: 13/140,934

(22) PCT Filed: Dec. 22, 2009
(86) PCT No.: PCT/EP2009/067773

§ 371 Date: Jun. 20, 2011

(30) Foreign Application Priority Data
Dec. 23, 2008 (EP) 08172837.0

(51) Int. Cl. A01N 25/00; A01P 3/00; A01P 5/00; A01P 7/04; A01P 1/00; A01P 13/02; A01P 7/02

(52) U.S. Cl. 504/361; 514/772.6; 514/772.4; 514/772.5

(57) ABSTRACT

The present patent application relates to a gel formulation that is stable for storage, comprising at least two substantially un-mixed hydrogels, wherein each hydrogel contains at least one electrolyte-sensitive thickener. Also, one of the hydrogels (phase A) contains at least one material A that is not compatible with at least one of the materials B contained in another hydrogel (phase B), or that is not compatible therewith in the amounts in which said materials B are contained in the gel formulation.

The present patent application relates to a storage-stable gel formulation with at least two essentially unmixed hydrogels, each hydrogel comprising at least one electrolyte-sensitive thickener. In addition, one of the hydrogels (phase A) comprises at least one substance A which is incompatible with at least one of the substances B present in an additional hydrogel (phase B) or is incompatible with at least one of the substances B present in an additional hydrogel (phase B) in the amounts in which these substances are present in the gel formulation.

Liquid product formulations, such as solutions, suspensions or emulsions, have a number of advantages in comparison with pulverulent presentations, for example no dust development, improved wetting properties and, generally, a better ability to be measured into exact doses.

However, with many liquid formulations, in particular with storage over relatively long periods of time, a sufficiently good storage stability is more difficult to achieve in comparison with the corresponding solid formulations. Thus, sediment formation, agglomeration, crystallization and/or syneresis (deposition of liquid formulation constituents) frequently occur.

These phenomena can generally be attributed to incompatibilities of components of the formulation with one another, thus to the incompatibility of several active substances with one another or of an active substance with an auxiliary, for example with a wetting agent.

Generally, these problems are solved by, for example, choosing more compatible auxiliaries for the respective active substance or formulating several active substances separately. The search for compatible formulation components is, however, very expensive and has to be carried out individually for each individual active substance. In addition, the separate formulating of different active substances is disadvantageous for commercialization reasons.

EP-A-0 225 287 describes storage-stable aqueous preparations of solid substances which are insoluble or sparingly soluble in water, which preparations comprise a synthetic electrolyte-sensitive thickening agent. In this system, however, no components are used which are incompatible with one another.

It was accordingly an object of the present invention to make available a product formulation which is liquid when used, which does not exhibit the disadvantages of the known liquid formulations and which in particular does not result in any compatibility problems of the constituents present therein.

The object is achieved through a storage-stable gel formulation with at least two essentially unmixed hydrogels.

A subject matter of the invention is accordingly a storage-stable gel formulation with at least two essentially unmixed hydrogels which comprises, in each hydrogel, at least one electrolyte-sensitive, preferably synthetic, thickener and which furthermore comprises, in one of the hydrogels, at least one substance A and, in an additional hydrogel, at least one substance B, at least one of the substances A being incompatible with at least one of the substances B in the amounts present in the gel formulation (or, in other words: in the amounts present in the respective phase).

“Incompatible” obviously refers in this connection to an incompatibility which then occurs if the substances A and B, which are incompatible with one another, are formulated together and, for example, are present as a mixture in a liquid formulation; in the gel formulation according to the invention, this incompatibility is naturally not present or it does not appear at least during a significantly longer space of time than would be the case with a combined formulation of the incompatible substances.

The hydrogel which comprises the at least one substance A is subsequently also referred to as phase A; analogously, the hydrogel which comprises the at least one substance B is subsequently also referred to as phase B, even if phases in the thermodynamic sense are not necessarily concerned.

A gel formulation is a preparation, in the form of a gel, of an active substance of any nature. A gel is a dimensionally stable, readily deformable, liquid-rich and gas-rich, finely dispersed colloidal system of at least two components which for the most part comprise a solid colloidally dispersed substance with long or highly branched particles (gelling agent; also known as thickening agent or thickener) and a liquid (generally water) as dispersing agent. In this connection, the solid substance is coherent, i.e. it forms, in the dispersing agent, a spongy three-dimensional network, the particles adhering to one another at different points (adhesion points). The pores of the coherent phase are filled with a liquid (“lyogel”; in the case of water: “hydrogel”). Both phases in this connection are completely interpenetrated (bicoherent). If the liquid of the gel is lost, so that the disperse phase is formed by a gas, the term xerogels is used; these naturally have an altered spatial arrangement of the network with substantially smaller interspaces between the structural elements and form a limiting state of the solid. Gels can also be described as viscoelastic fluids; their fluid properties lie between those of an ideal liquid and those of an ideal solid.

The gel formulation according to the invention comprises at least two hydrogels. Hydrogels are understood to mean, in the context of the present invention, those gels which comprise at least 5% by weight of water, preferably at least 10% by weight of water and in particular at least 15% by weight of water, based on the total weight of the gel. The term “hydrogel” does not, however, exclude them from also comprising other liquids, for example organic solvents or liquid active substances or auxiliaries.

The gel formulation according to the invention can, before its actual use, be further liquefied by stirring in a small amount of an electrolyte (i.e., it is converted into a fluid formulation by addition of electrolyte) and is then ready for use.

The details subsequently given of suitable and preferred embodiments and properties of the gel formulation according to the invention, in particular of the components A and B, of the thickeners and additional constituents optionally present, of the electrolyte and the like, are valid both alone, taken per se, and in particular in any conceivable combination with one another.

The hydrogels present in the gel formulation according to the invention can be in contact with one another, i.e. have interfaces which are in touch; however, they can also be physically separated, for example by a separating film or a separating wall. With more than two hydrogels, the hydrogels can have any relative arrangement; thus, the at least three hydrogels can be arranged in a stratoform, polygonal or concentric manner, and the like.

The hydrogels present in the gel formulation according to the invention are preferably in contact, i.e. have at least one phase boundary which is touching. With “n” hydrogels, at least “n-1” interfaces are preferably present.

It is essential according to the invention for the hydrogels present in the gel formulation according to the invention to essentially not mix with one another. This means that the interfaces between the individual gels are so stable that the substances which are incompatible with one another do not diffuse into one another over a relatively lengthy period of time. To be more precise, the hydrogels are of such a nature that at most 5% by weight, preferably at most 2% by weight and in particular at most 1% by weight of the at least one substance A present in phase A which is incompatible with the at least one substance B from phase B or is incompatible with the at least one substance B from phase B in the amounts in which they are each present in phases A and B diffuse into phase B in 4 weeks at 20° C. and, conversely, at most 5% by weight, preferably at most 2% by weight and in particular at most 1% by weight of the at least one substance B present in phase B which is incompatible with the at least one substance A from phase A or is incompatible with the at least one substance A from phase A in the amounts in which they are each present in the phases A and B diffuse into phase A in 4 weeks at 20° C.

The hydrogels present in the gel formulation according to the invention are dimensionally stable. Preferably, they have a viscosity of at least 1000 mPa·s, e.g. of 1000 to 10⁶ mPa·s or preferably 1000 to 10⁵ mPa·s or in particular 1000 to 10⁴ mPa·s; particularly preferably of at least 3000 mPa·s, e.g. of 3000 to 10⁶ mPa·s or preferably of 3000 to 10⁵ mPa·s or in particular of 3000 to 10⁴ mPa·s; very preferably of at least 4000 mPa·s, e.g. of 4000 to 10⁶ mPa·s or preferably of 4000 to 10⁵ mPa·s or in particular of 4000 to 10⁴ mPa·s; and in particular of at least 5000 mPa·s, e.g. of 5000 to 10⁶ mPa·s or preferably of 5000 to 10⁵ mPa·s or in particular of 5000 to 10⁴ mPa·s.

The figures given for the viscosity in the context of the present invention refer to values as obtained using a Brookfield viscometer (1.5 rpm, Sp 63) at a temperature of 25° C.

The lack of compatibility or incompatibility of the at least one substance A with the at least one substance B can be expressed in different ways. Incompatibility describes in principle any reduction in effect or reduction in the practical applicability caused chemically or physicochemically. Thus, an incompatibility can mean that the substances A and B react with one another to give undesirable or less effective products. Substance A may also promote, for example catalytically, a change in substance B, for example a decomposition or a reaction with an additional component of the formulation, or vice versa. However, an incompatibility can also be expressed in that substance A brings about an increased precipitation or crystallization of the substance B or vice versa in the dispersion medium on which the gel formulation is based. An incompatibility can furthermore result in phase separation of the desired liquid formulation.

Precipitation is understood to mean, in the context of the present invention, both the transformation of a substance from the dissolved into the solid state (for example by precipitation, e.g. by crystallization) and the transformation from a finely dispersed state (e.g., emulsion, suspension, suspoemulsion) into a more coarsely dispersed state which is visible to the eye or is at least of such a magnitude that it interferes with the planned application of the formulation, for example because the precipitate blocks nozzles or filters.

Ostwald ripening is understood to mean the growth of larger crystals at the expense of the smaller crystals in their saturated or supersaturated solution. Through this, the smaller particles gradually disappear and the dispersion changes its particle size distribution to a uniform size. A disadvantage of Ostwald ripening is the formation of large crystals which can interfere with some applications as they can, for example, block nozzles or filters.

Preferably, the gel formulation according to the invention is used to prevent at least one of the substances A bringing about, after a certain time, the precipitation of at least a portion of at least one of the substances B or to prevent at least one of the substances B bringing about, after a certain time, the precipitation of at least a portion of at least one of the substances A or to prevent the at least one substance A and the at least one substance B mutually at least partially precipitating after a certain time. “After a certain time” means that the precipitation does not have to start suddenly after the mixing of the substances A and B but also after a certain storage time, e.g. after a few hours or days. In this connection, “after a certain time” preferably means that at least one of the substances A would bring about the precipitation of at least a portion of at least one of the substances B at the latest after 4 weeks, preferably at the latest after 2 weeks, after the joint formulating of the substances A and B in a liquid formulation or that at least one of the substances B would bring about the precipitation of at least one of the substances A at the latest after 4 weeks, preferably at the latest after 2 weeks, after the joint formulating of the substances A and B in a liquid formulation or that the at least one substance A and the at least one substance B would be at least partially mutually precipitated at the latest after 4 weeks, preferably at the latest after 2 weeks, after the joint formulating of the substances A and B in a liquid formulation. “At least partially precipitated” means that such a large portion of the substance or of the substance B or of the two substances is precipitated that it interferes in the subsequent use, for example because it results in blocking of any nozzles through which the formulation is led, or that the active substance can no longer satisfactorily exhibit its effect.

In other words, a preferred embodiment of the invention relates to a storage-stable gel formulation, including at least two essentially unmixed hydrogels, comprising in each hydrogel at least one electrolyte-sensitive thickener and furthermore comprising in one of the hydrogels (phase A) at least one substance A and in an additional hydrogel (phase B) at least one substance B, in which at least one of the substances A in an imaginary liquid formulation, for example in a liquid formulation which forms the basis of the gel formulation according to the invention or one of its hydrogels or in a liquid formulation which is formed by addition of at least one electrolyte to the gel formulation according to the invention, would bring about, after a certain time, the precipitation of at least a portion of at least one of the substances B; or at least one of the substances B in an imaginary liquid formulation, for example in a liquid formulation which forms the basis of the gel formulation according to the invention or one of its hydrogels or in a liquid formulation which is formed by addition of at least one electrolyte to the gel formulation according to the invention, would bring about, after a certain time, the precipitation of at least a portion of at least one of the substances A; or the substances A and B in an imaginary liquid formulation, for example in a liquid formulation which forms the basis of the gel formulation according to the invention or one of its hydrogels or in a liquid formulation which is formed by addition of at least one electrolyte to the gel formulation according to the invention, would be at least partially mutually precipitated after a certain time.

Alternatively, the gel formulation according to the invention is preferably used to prevent at least one of the substances A promoting/bringing about, after a certain time, the crystal growth (Ostwald ripening) of at least a portion of at least one of the substances B or at least one of the substances B promoting/bringing about, after a certain time, the crystal growth (Ostwald ripening) of at least a portion of at least one of the substances A. “After a certain time” means that the Ostwald ripening does not have to start suddenly after the mixing of the substances A and B but also after a certain storage time, e.g. after a few hours or days. In this connection, “after a certain time” preferably means that at least one of the substances A would bring about the crystal growth (Ostwald ripening) of at least a portion of at least one of the substances B at the latest after 4 weeks, preferably at the latest after 2 weeks, after the joint formulating of the substances A and B in a liquid formulation or that at least one of the substances B would bring about the crystal growth (Ostwald ripening) of at least one of the substances A at the latest after 4 weeks, preferably at the latest after 2 weeks, after the joint formulating of the substances A and B in a liquid formulation. The term “bring about the crystal growth (Ostwald ripening) of at least a portion of at least one of the substances” preferably means in this connection that such a large portion of the substance A or of the substance B is precipitated or the crystals have acquired such a size that it interferes in the subsequent use, for example because it results in blocking of any nozzles through which the formulation is led, or that the active substance can no longer satisfactorily exhibit its effect.

In other words, a preferred embodiment of the invention relates to a storage-stable gel formulation, including at least two essentially unmixed hydrogels, comprising in each hydrogel at least one electrolyte-sensitive thickener and furthermore comprising in one of the hydrogels (phase A) at least one substance A and in an additional hydrogel (phase B) at least one substance B, in which at least one of the substances A in an imaginary liquid formulation, for example in a liquid formulation which forms the basis of the gel formulation of the invention or one of its hydrogels or in a liquid formulation which is formed by addition of at least one electrolyte to the gel formulation according to the invention, would bring about the crystal growth (Ostwald ripening) of at least a portion of at least one of the substances B after a certain time; or at least one of the substances B in an imaginary liquid formulation, for example in a liquid formulation which forms the basis of the gel formulation according to the invention or one of its hydrogels or in a liquid formulation which is formed by addition of at least one electrolyte to the gel formulation according to the invention, would bring about the crystal growth (Ostwald ripening) of at least a portion of at least one of the substances A after a certain time.

That stated previously is valid with regard to the expressions “after a certain time” and “bring about at least partially the crystal growth (Ostwald ripening)”.

Thus, for example, in Ostwald ripening, at least one of the substances A increases the solubility in water of the finely dispersed particles of an aqueous dispersion of the at least one substance B which comprises from 5 to 100% by weight of water, the more coarsely dispersed particles simultaneously growing; and/or at least one of the substances B increases the solubility in water of the finely dispersed particles of an aqueous dispersion of the at least one substance A which comprises from 5 to 100% by weight of water, the more coarsely dispersed particles simultaneously growing.

In a preferred embodiment, at least one of the substances A and/or at least one of the substances B is sparingly soluble in water. “Sparingly soluble in water” means in this connection that at most 5 g, preferably at most 2 g and in particular at most 1 g of the substance are soluble in 1 l of water under S.T.P. (T=25° C. +/−20%, p=101 325 pascals +/−20%).

A particularly preferred embodiment of the invention relates to a storage-stable gel formulation including at least two essentially unmixed hydrogels, comprising in each hydrogel at least one electrolyte-sensitive thickener and furthermore comprising in one of the hydrogels (phase A) at least one substance A and in an additional hydrogel (phase B) at least one substance B, the at least one substance A and the at least one substance B being provided in such a way that, when formulated together (i.e., A and B are present in the mixture in a phase), at least one of the substances A would promote the precipitation of at least one of the substances B in an aqueous dispersion comprising from 5 to 100% by weight of water and/or at least one of the substances B would promote the precipitation of at least one of the substances A in an aqueous dispersion comprising from 5 to 100% by weight of water.

A particularly preferred embodiment of the invention additionally relates to a storage-stable gel formulation, including at least two essentially unmixed hydrogels, comprising in each hydrogel at least one electrolyte-sensitive thickener and furthermore comprising in one of the hydrogels (phase A) at least one substance A and in an additional hydrogel (phase B) at least one substance B, the at least one substance A and the at least one substance B being provided in such a way that, when formulated together (i.e., A and B are present in the mixture in a phase), at least one of the substances A would promote the crystal growth (Ostwald ripening) of at least one of the substances B in an aqueous dispersion comprising from 5 to 100% by weight of water and/or at least one of the substances B would promote the crystal growth (Ostwald ripening) of at least one of the substances A in an aqueous dispersion comprising from 5 to 100% by weight of water.

A very preferred subject matter of the invention is a storage-stable gel formulation, including at least two essentially unmixed hydrogels, comprising in each hydrogel at least one electrolyte-sensitive thickener and furthermore comprising in one of the hydrogels (phase A) at least one substance A and in an additional hydrogel (phase B) at least one substance B, the at least one substance A and the at least one substance B being provided in such a way that, when formulated together (i.e., A and B are present in the mixture in a phase), at least one of the substances A would lower the solubility in water of at least one of the substances B and/or at least one of the substances B would lower the solubility in water of at least one of the substances A.

In an even more strongly preferred embodiment of the invention, phase A comprises at least one essentially water-insoluble plant protection agent and optionally at least one dispersing agent. Preferably, in this connection, phase B comprises a plant protection agent other than the plant protection agent of the phase A and/or an adjuvant. In this connection, the plant protection agent of the phase A is incompatible with the plant protection agent of the phase B and/or with the adjuvant of the phase B or at least is incompatible with each of the amounts present in the gel formulation in the phases A and B.

In a particular embodiment of the invention, phase A is a suspension concentrate (SC) thickened with the at least one electrolyte-sensitive thickener or a suspoemulsion (SE) thickened with the at least one electrolyte-sensitive thickener or an aqueous emulsion (EW) thickened with the at least one electrolyte-sensitive thickener which preferably includes at least one plant protection agent and phase B is likewise a suspension concentrate (SC) thickened with the at least one electrolyte-sensitive thickener or a suspoemulsion (SE) thickened with the at least one electrolyte-sensitive thickener or an aqueous emulsion (EW) thickened with the at least one electrolyte-sensitive thickener which preferably includes at least one plant protection agent or phase B is an aqueous solution or emulsion thickened with the at least one electrolyte-sensitive thickener which includes at least one adjuvant.

The plant protection agents relate to all common categories, for example herbicides, fungicides, insecticides, acaricides, nematicides, bactericides, growth regulators and the like.

Examples of fungicides are:

### Strobilurins

azoxystrobin, dimoxystrobin, enestroburin, fluoxastrobin, kresoxim-methyl, metominostrobin, orysastrobin, picoxystrobin, pyraclostrobin, pyribencarb, trifloxystrobin, 2-(2-(6-(3-chloro-2-methylphenoxy)-5-fluoropyrimidin-4-yloxy)phenyl)-2-methoxyimino-N-methylacetamide, methyl 2-(ortho-((2,5-dimethylphenyl)oxymethylene)phenyl)-3-methoxyacrylate, methyl 3-methoxy-2-(2-(N-(4-methoxyphenyl)cyclopropanecarboximidoylsulfanylmethyl)phenyl)acrylate;

### Carboxamides

carboxanilides: benalaxyl, benalaxyl-M, benodanil, bixafen, boscalid, carboxin, fenfuram, fenhexamide, flutolanil, furametpyr, isotianil, kiralaxyl, mepronil, metalaxyl, ofurace, oxadixyl, oxycarboxin, penthiopyrad, tecloftalam, thifluzamide, tiadinil, 2-amino-4-methylthiazole-5-carboxanilide, 2-chloro-N-(1,1,3-trimethylindan-4-yl)nicotinamide, N-(3′,4′-dichloro-5-fluorobiphenyl-2-yl)-3-difluoromethyl-1-methyl-1H-pyrazole-4-carboxamide, 5-fluoro-1,3-dimethyl-1H-pyrazole-4-carboxylic acid [2-(1,3-dimethylbutyl)phenyl]amide, N-(4′-chloro-3′,5-difluorobiphenyl-2-yl)-3-difluoromethyl-1-methyl-1H-pyrazole-4-carboxamide, N-(4′-chloro-3′,5-difluorobiphenyl-2-yl)-3-trifluoromethyl-1-methyl-1H-pyrazole-4-carboxamide, N-(3′,4′-dichloro-5-fluorobiphenyl-2-yl)-3-trifluoromethyl-1-methyl-1H-pyrazole-4-carboxamide, N-(3′,5-difluoro-4′-methylbiphenyl-2-yl)-3-difluoromethyl-1-methyl-1H-pyrazole-4-carboxamide, N-(3′,5-difluoro-4′-methylbiphenyl-2-yl)-3-trifluoromethyl-1-methyl-1H-pyrazole-4-carboxamide, N-[2-(bicyclopropyl-2-yl)phenyl]-3-difluoromethyl-1-methyl-1H-pyrazole-4-carboxamide, N-[2-cis-bicyclopropyl-2-yl)-phenyl]-3-difluoromethyl-1-methyl-1H-pyrazole-4-carboxamide, N-[2-trans-bicyclopropyl-2-yl)phenyl]-3-difluoromethyl-1-methyl-1H-pyrazole-4-carboxamide;
carboxylic acid morpholides: dimethomorph, flumorph;
benzamides: flumetover, fluopicolide, fluopyram, zoxamide, N-(3-ethyl-3,5,5-trimethylcyclohexyl)-3-formylamino-2-hydroxybenzamide;
other carboxamides: carpropamid, diclocymet, mandipropamid, oxytetracycline, silthiofam, N-(6-methoxypyridin-3-yl)cyclopropanecarboxamide;

### Azoles

triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazol, penconazole, propiconazole, prothioconazole, simeconazole, tebuconazole, tetraconazole, triadimefon, triadimenol, triticonazole, uniconazole, 1-(4-chlorophenyl)-2-(1,2,4-triazol-1-yl)cycloheptanol;
imidazoles: cyazofamid, imazalil, imazalil sulfate, pefurazoate, prochloraz, triflumizole;
benzimidazoles: benomyl, carbendazim, fuberidazole, thiabendazole;
others: ethaboxam, etridiazole, hymexazol, 1-(4-chlorophenyl)-1-(propyn-2-yloxy)-3-(4-(3,4-dimethoxyphenyl)isoxazol-5-yl)propan-2-one;

### Nitrogen-comprising Heterocyclyl Compounds

pyridines: fluazinam, pyrifenox, 3-[5-(4-chlorophenyl)-2,3-dimethylisoxazolidin-3-yl]pyridine, 2,3,5,6-tetrachloro-4-(methanesulfonyl)pyridine, 3,4,5-trichloropyridine-2,6-dicarbonitrile, N-(1-(5-bromo-3-chloropyridin-2-yl)ethyl)-2,4-dichloronicotinamide, N-((5-bromo-3-chloropyridin-2-yl)methyl)-2,4-dichloronicotinamide;
pyrimidines: bupirimate, cyprodinil, diflumetorim, fenarimol, ferimzone, mepanipyrim, nitrapyrin, nuarimol, pyrimethanil;
pyrroles: fludioxonil, fenpiclonil;
morpholines: aldimorph, dodemorph, dodemorph acetate, fenpropimorph, tridemorph;
dicarboximides: fluoroimide, iprodione, procymidone, vinclozolin;
others: acibenzolar-S-methyl, amisulbrom, anilazine, blasticidin-S, captafol, captan, chinomethionat, dazomet, debacarb, diclomezine, difenzoquat, difenzoquat metilsulfate, famoxadone, fenamidone, fenoxanil, fenpropidin, folpet, octhilinone, oxolinic acid, piperalin, probenazole, proquinazid, pyroquilon, quinoxyfen, triazoxide, tricyclazole, triforine, 5-chloro-7-(4-methylpiperidin-1-yl)-6-(2,4,6-trifluorophenyl)-[1,2,4]triazolo[1,5-a]pyrimidine, 2-butoxy-6-iodo-3-propylchromen-4-one;

### Carbamates and Dithiocarbamates

thio- and dithiocarbamates: ferbam, mancozeb, maneb, metam, methasulfocarb, metiram, propineb, thiram, zineb, ziram;
carbamates: diethofencarb, benthiavalicarb, iprovalicarb, propamocarb, propamocarb hydrochloride, valiphenal, 4-fluorophenyl N-(1-(1-(4-cyanophenyl)ethylsulfonyl)but-2-yl)carbamate;

### Other Fungicides

guanidines: dodine, dodine free base, guazatine, guazatine acetate, iminoctadine, iminoctadine triacetate, iminoctadine trialbesilate;
antibiotics: kasugamycin, kasugamycin hydrochloride hydrate, polyoxins, streptomycin, validamycin A;
nitrophenyl derivatives: binapacryl, dicloran, dinobuton, dinocap, nitrothal-isopropyl, tecnazene;
organometallic compounds: fentin salts, such as, for example, fentin acetate, fentin chloride, fentin hydroxide;
sulfur-comprising heterocyclyl compounds: isoprothiolane, dithianon;
organophosphorus compounds: edifenphos, fosetyl, fosetyl-aluminum, iprobenfos, pyrazophos, tolclofos-methyl;
organochlorine compounds: chlorothalonil, dichlofluanid, dichlorophen, flusuifamide, hexachlorobenzene, pencycuron, pentachlorophenol and its salts, phthalide, quintozene, thiophanate-methyl, tolylfluanid, N-(4-chloro-2-nitrophenyl)-N-ethyl-4-methylbenzenesulfonamide;
inorganic active substances: phosphorous acid and its salts, sulfur, Bordeaux mixture, copper salts, such as, for example, copper acetate, copper hydroxide, copper oxychloride, basic copper sulfate;
others: biphenyl, bronopol, cyflufenamid, cymoxanil, diphenylamine, metrafenone, mildiomycin, oxine-copper, prohexadione-calcium, spiroxamine, tolylfluanid, N-(cyclopropylmethoxyimino(6-difluoromethoxy-2,3-difluorophenyl)methyl)-2-phenylacetamide, N′-(4-(4-chloro-3-(trifluoromethyl)phenoxy)-2,5-dimethylphenyl)-N-ethyl-N-methylformamidine, N′-(4-(4-fluoro-3-(trifluoromethyl)phenoxy)-2,5-dimethylphenyl)-N-ethyl-N-methylformamidine, N′-(2-methyl-5-trifluoromethyl-4-(3-(trimethylsilanyl)propoxy)phenyl)-N-ethyl-N-methylformamidine, N′-(5-difluoromethyl-2-methyl-4-(3-(trimethylsilanyl)propoxy)phenyl)-N-ethyl-N-methylformamidine.

Examples of Insecticides are:

### Organo(thio)phosphates:

acephate, azamethiphos, azinphos-ethyl, azinphos-methyl, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, flupyrazofos, fosthiazate, heptenophos, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion;

### Carbamates:

aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, triazamate;

### Pyrethroids:

acrinathrin, allethrin, d-cis-trans-allethrin, d-trans-allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, permethrin, phenothrin, prallethrin, resmethrin, RU 15525, silafluofen, tefluthrin, tetramethrin, tralomethrin, transfluthrin, ZXI 8901;

### Juvenile Hormone Mimetics:

fenoxycarb, hydroprene, kinoprene, methoprene, pyriproxyfen;

### Nicotine Receptor Agonists/antagonists:

acetamiprid, bensultap, cartap hydrochloride, clothianidin, dinotefuran, imidacloprid, thiamethoxam, nitenpyram, nicotine, spinosad (allosteric agonist), thiacloprid, thiocyclam, thiosultap-sodium and AKD1022;

### GABA Antagonists:

chlordane, endosulfan, gamma-HCH (lindane), acetoprole, ethiprole, fipronil, pyrafluprole, pyriprole, vaniliprole, the phenylpyrazole compound of the formula Γ¹

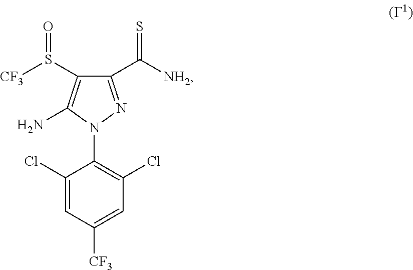

### Chloride Channel Activators:

abamectin, emamectin benzoate, milbemectin, lepimectin;

### METI I Compounds:

fenazaquin, fenpyroximate, pyrimidifen, pyridaben, tebufenpyrad, tolfenpyrad, flufenerim, rotenone;

### METI II and III Compounds:

acequinocyl, fluacrypyrim, hydramethylnon;

### Uncouplers of Oxidative Phosphorylation:

chlorfenapyr, DNOC;

### Inhibitors of Oxidative Phosphorylation:

azocyclotin, cyhexatin, diafenthiuron, fenbutatin oxide, propargite, tetradifon;

### Molting Disruptors:

cyromazine, chromafenozide, halofenozide, methoxyfenozide, tebufenozide;

### Synergists:

piperonyl butoxide, tribufos;

### Sodium Channel Blockers:

indoxacarb, metaflumizone;

### Fumigants:

methyl bromide, chloropicrin sulfuryl fluoride;

### Selective Antifeedants:

cryolite, pymetrozine, flonicamid;

### Mite Growth Inhibitors:

clofentezine, hexythiazox, etoxazole;

### Chitin Synthesis Inhibitors:

buprofezin, bistrifluron, chlorfluazuron, diflubenzuron, flucycloxuron, flufenoxuron, hexaflumuron, lufenuron, novaluron, noviflumuron, teflubenzuron, triflumuron;

### Lipid Biosynthesis Inhibitors:

spirodiclofen, spiromesifen, spirotetramat;

### Octopaminergic Agonists:

amitraz;

### Ryanodine Receptor Modulators:

flubendiamide;

### Various:

aluminum phosphide, amidoflumet, benclothiaz, benzoximate, bifenazate, borax, bromopropylate, cyanide, cyenopyrafen, cyflumetofen, quinomethionate, dicofol, fluoroacetate, phosphine, pyridalyl, pyrifluquinazone, sulfur, potassium antimonyl tartrate, N-R′-2,2-dihalo-1-R″-cyclopropanecarboxamide 2-(2,6-dichloro-α,α,α-trifluoro-p-tolyl)hydrazone or N-R′-2,2-di(R′″)propionamide-2-(2,6-dichloro-α,α,α-trifluoro-p-tolyl)hydrazone, in which R′ is methyl or ethyl, halo is chlorine or bromine, R″ is hydrogen or methyl and R′″ is methyl or ethyl;

### Anthranilamides:

chloranthraniliprole, the compound of the formula Γ²

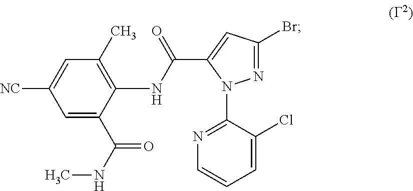

### Malononitriles:

CF₃(CH₂)₂C(CN)₂CH₂(CF₂)₃CF₂H, CF₃(CH₂)₂C(CN)₂CH₂(CF₂)₅CF₂H, CF₃(CH₂)₂C(CN)₂(CH₂)₂C(CF₃)₂F, CF₃(CH₂)₂C(CN)₂(CH₂)₂(CF₂)₃CF₃, CF₂H(CF₂)₃CH₂C(CN)₂CH₂(CF₂)₃CF₂H, CF₃(CH₂)₂C(CN)₂CH₂(CF₂)₃CF₃, CF₃(CF₂)₂CH₂C(CN)₂CH₂(CF₂)₃CF₂H, CF₃CF₂CH₂C(CN)₂CH₂(CF₂)₃CF₂H, 2-(2,2,3,3,4,4,5,5-octafluoropentyl)-2-(3,3,4,4,4-pentafluorobutyl)malonodinitrile and CF₂HCF₂CF₂CF₂CH₂C(CN)₂CH₂CH₂CF₂CF₃;

### Microbial Disruptors:

Bacillus thuringiensis subsp. israelensi, Bacillus sphaericus, Bacillus thuringiensis subsp. aizawai, Bacillus thuringiensis subsp. kurstaki, Bacillus thuringiensis subsp. tenebrionis;

### Alkynyl Ethers of the Formulae Γ⁴ and Γ⁵:

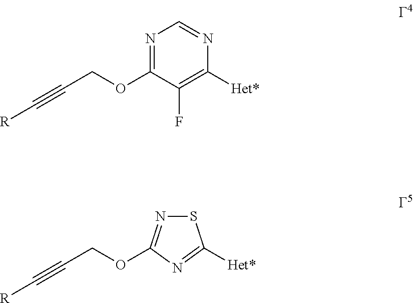 [0091] in which R is methyl or ethyl and Het* is 3,3-dimethylpyrrolidin-1-yl, 3-methylpiperidin-1-yl, 3,5-dimethylpiperidin-1-yl, 3-trifluoromethylpiperidin-1-yl, hexahydroazepin-1-yl, 2,6-dimethylhexahydroazepin-1-yl or 2,6-dimethylmorpholin-4-yl. These compounds are described, for example, in JP 2006131529.

Examples of Herbicides are:

### Amide Herbicides:

allidochlor, amicarbazone, beflubutamid, benzadox, benzipram, bromobutide, cafenstrole, CDEA, cyprazole, dimethenamid, dimethenamid-P, diphenamid, epronaz, etnipromid, fentrazamide, flucarbazone, flupoxam, fomesafen, halosafen, isocarbamid, isoxaben, napropamide, naptalam, pethoxamid, propyzamide, quinonamid, saflufenacil, tebutam;

### Anilide Herbicides:

chloranocryl, cisanilide, clomeprop, cypromid, diflufenican, etobenzanid, fenasulam, flufenacet, flufenican, ipfencarbazone, mefenacet, mefluidide, metamifop, monalide, naproanilide, pentanochlor, picolinafen, propanil, sulfentrazone;

### Arylalanine Herbicides:

benzoylprop, flamprop, flamprop-M;

### Chloroacetanilide Herbicides:

acetochlor, alachlor, butachlor, butenachlor, delachlor, diethatyl, dimethachlor, metazachlor, metolachlor, S-metolachlor, pretilachlor, propachlor, propisochlor, prynachlor, terbuchlor, thenylchlor, xylachlor;

### Sulfonanilide Herbicides:

benzofluor, cloransulam, diclosulam, florasulam, flumetsulam, metosulam, perfluidone, pyrimisulfan, profluazol;

### Sulfonamide Herbicides:

asulam, carbasulam, fenasulam, oryzalin, penoxsulam, pyroxsulam;

### Thioamide Herbicides:

bencarbazone, chlorthiamid;

### Antibiotic Herbicides:

bilanafos;

### Aromatic Acid Herbicides:

### Benzoic Acid Herbicides:

chloramben, dicamba, 2,3,6-TBA, tricamba;

### Pyrimidinyloxybenzoic Acid Herbicides:

bispyribac, pyriminobac;

Pyrimidinylthiobenzoic Acid Herbicides:
pyrithiobac;

### Phthalic Acid Herbicides:

chlorthal;

### Picolinic Acid Herbicides:

aminopyralid, clopyralid, picloram;

### Quinolinecarboxylic Acid Herbicides:

quinclorac, quinmerac;

### Arsenic-comprising Herbicides:

cacodylic acid, CMA, DSMA, hexaflurate, MAA, MAMA, MSMA, potassium arsenite, sodium arsenite;

### Benzoylcyclohexanedione Herbicides:

mesotrione, sulcotrione, tefuryltrione, tembotrione;

### Benzofuranyl Alkylsulfonate Herbicides:

benfuresate, ethofumesate;

### Benzothiazole Herbicides:

benazolin, benzthiazuron, fenthiaprop, mefenacet, methabenzthiazuron;

### Carbamate Herbicides:

asulam, carboxazole, chlorprocarb, dichlormate, fenasulam, karbutilate, terbucarb;

### Carbanilate Herbicides:

barban, BCPC, carbasulam, carbetamide, CEPC, chlorbufam, chlorpropham, CPPC, desmedipham, phenisopham, phenmedipham, phenmedipham-ethyl, propham, swep;

### Cyclohexene Oxime Herbicides:

alloxydim, butroxydim, clethodim, cloproxydim, cycloxydim, profoxydim, sethoxydim, tepraloxydim, tralkoxydim;

### Cyclopropylisoxazole Herbicides:

isoxachlortole, isoxaflutole;

### Dicarboximide Herbicides:

cinidon-ethyl, flumezin, flumiclorac, flumioxazin, flumipropyn;

### Dinitroaniline Herbicides:

benfluralin, butralin, dinitramine, ethalfluralin, fluchloralin, isopropalin, methalpropalin, nitralin, oryzalin, pendimethalin, prodiamine, profluralin, trifluralin;

### Dinitrophenol Herbicides:

dinofenate, dinoprop, dinosam, dinoseb, dinoterb, DNOC, etinofen, medinoterb;

### Diphenyl Ether Herbicides:

ethoxyfen;

### Nitrophenyl Ether Herbicides:

acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen, oxyfluorfen;

### Dithiocarbamate Herbicides:

dazomet, metam;

### Halogenated Aliphatic Herbicides:

alorac, chloropon, dalapon, flupropanate, hexachloroacetone, iodomethane, methyl bromide, monochloroacetic acid, SMA, TCA;

### Imidazolinone Herbicides:

imazamethabenz, imazamox, imazapic, imazapyr, imazaquin, imazethapyr;

### Inorganic Herbicides:

ammonium sulfamate, borax, calcium chlorate, copper sulfate, iron sulfate, potassium azide, potassium cyanate, sodium azide, sodium chlorate, sulfuric acid;

### Nitrile Herbicides:

bromobonil, bromoxynil, chloroxynil, dichlobenil, iodobonil, ioxynil, pyraclonil;

### Organophosphorus Herbicides:

amiprofos-methyl, anilofos, bensulide, bilanafos, butamifos, 2,4-DEP, DMPA, EBEP, fosamine, glufosinate, glufosinate-P, glyphosate, piperophos;

### Oxadiazolone Herbicides:

dimefuron, methazole, oxadiargyl, oxadiazon;

### Oxazole Herbicides:

carboxazole, isouron, isoxaben, isoxachlortole, isoxaflutole, monisouron, pyroxasulfone, topramezone;

### Phenoxy Herbicides:

bromofenoxim, clomeprop, 2,4-DEB, 2,4-DEP, difenopenten, disul, erbon, etnipromid, fenteracol, trifopsime;

### Phenoxyacetic Acid Herbicides:

4-CPA, 2,4-D, 3,4-DA, MCPA, MCPA-thioethyl, 2,4,5-T;

### Phenoxybutyric Acid Herbicides:

4-CPB, 2,4-DB, 3,4-DB, MCPB, 2,4,5-TB;

### Phenoxypropionic Acid Herbicides:

cloprop, 4-CPP, dichlorprop, dichlorprop-P, 3,4-DP, fenoprop, mecoprop, mecoprop-P;

### Aryloxyphenoxypropionic Herbicides:

chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, trifop;
Phenylenediamine Herbicides:
dinitramine, prodiamine;

### Pyrazole Herbicides:

azimsulfuron, difenzoquat, halosulfuron, metazachlor, pyrazosulfuron, pyroxasulfone;

### Benzoylpyrazole Herbicides:

benzofenap, pyrasulfotole, pyrazolynate, pyrazoxyfen, topramezone;

### Phenylpyrazole Herbicides:

fluazolate, nipyraclofen, pyraflufen;

### Pyridazine Herbicides:

credazine, pyridafol, pyridate;

### Pyridazinone Herbicides:

brompyrazon, chloridazon, dimidazon, flufenpyr, metflurazon, norflurazon, oxapyrazon, pydanon;

### Pyridine Herbicides:

aminopyralid, cliodinate, clopyralid, diflufenican, dithiopyr, flufenican, fluroxypyr, haloxydine, picloram, picolinafen, pyriclor, pyroxsulam, thiazopyr, triclopyr;

### Pyrimidinediamine Herbicides:

iprymidam, tioclorim;

### Quaternary Ammonium Herbicides:

cyperquat, diethamquat, difenzoquat, diquat, morfamquat, paraquat;

### Thiocarbamate Herbicides:

butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate, vernolate;

### Thiocarbonate Herbicides:

dimexano, EXD, proxane;

### Thiourea Herbicides:

methiuron;

### Triazine Herbicides:

dipropetryn, indaziflam, triaziflam, trihydroxytriazine;

### Chlorotriazine Herbicides:

atrazine, chlorazine, cyanazine, cyprazine, eglinazine, ipazine, mesoprazine, procyazine, proglinazine, propazine, sebuthylazine, simazine, terbuthylazine, trietazine;

### Methoxytriazine Herbicides:

atraton, methometon, prometon, secbumeton, simeton, terbumeton;

### Methylthiotriazine Herbicides:

ametryn, aziprotryne, cyanatryn, desmetryn, dimethametryn, methoprotryne, prometryn, simetryn, terbutryn;

### Triazinone Herbicides:

ametridione, amibuzin, hexazinone, isomethiozin, metamitron, metribuzin;

### Triazole Herbicides:

amitrole, cafenstrole, epronaz, flupoxam;

### Triazolone Herbicides:

amicarbazone, bencarbazone, carfentrazone, flucarbazone, ipfencarbazone, propoxycarbazone, sulfentrazone, thiencarbazone;

### Triazolopyrimidine Herbicides:

cloransulam, diclosulam, florasulam, flumetsulam, metosulam, penoxsulam, pyroxsulam;

### Uracil Herbicides:

benzfendizone, bromacil, butafenacil, flupropacil, isocil, lenacil, saflufenacil, terbacil;

### Urea Herbicides:

benzthiazuron, cumyluron, cycluron, dichloralurea, diflufenzopyr, isonoruron, isouron, methabenzthiazuron, monisouron, noruron;

### Phenylurea Herbicides:

anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluron, phenobenzuron, siduron, tetrafluron, thidiazuron;

### Sulfonylurea Herbicides:

Pyrimidinylsulfonylurea herbicides: amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, nicosulfuron, orthosulfamuron, oxasulfuron, primisulfuron, propyrisulfuron, pyrazosulfuron, rimsulfuron, sulfometuron, sulfosulfuron, trifloxysulfuron, Triazinylsulfonylurea herbicides: chlorsulfuron, cinosulfuron, ethametsulfuron, iodosulfuron, metsulfuron, prosulfuron, thifensulfuron, triasulfuron, tribenuron, triflusulfuron, tritosulfuron;

### Thiadiazolylurea Herbicides:

buthiuron, ethidimuron, tebuthiuron, thiazafluron, thidiazuron;

### Unclassified Herbicides:

acrolein, allyl alcohol, aminocyclopyrachlor, azafenidin, bentazone, benzobicyclon, buthidazole, calcium cyanamide, cambendichlor, chlorfenac, chlorfenprop, chlorflurazole, chlorflurenol, cinmethylin, clomazone, CPMF, cresol, cyanamide, ortho-dichlorobenzene, dimepiperate, endothal, fluoromidine, fluridone, flurochloridone, flurtamone, fluthiacet, indanofan, methyl isothiocyanate, OCH, oxaziclomefone, pentachlorophenol, pentoxazone, phenylmercury acetate, pinoxaden, prosulfalin, pyribenzoxim, pyriftalid, quinoclamine, rhodethanil, sulglycapin, thidiazimin, tridiphane, trimeturon, tripropindan, tritac.

Preferably, the plant protection agents are chosen from those which are insoluble or sparingly soluble in water. The term “sparingly soluble in water” means in this connection that at most 5 g, preferably at most 2 g and in particular at most 1 g of the substance are soluble in 1 l of water under S.T.P. (T=25° C. +/−20%, p=101 325 pascals +/−20%).

In plant protection, adjuvants are auxiliaries which increase the activity of an active substance (here: plant protection agent) and/or its selectivity with regard to the desired effect (e.g., fungicidal, insecticidal, herbicidal, bactericidal, nematicidal or growth-regulating effect) but which, taken per se, exhibit no or only a very slight effect with regard to the plant protection action. The action of adjuvants is in many cases based on their surface activity, which improves the contact of the application form of the active substance, generally an aqueous spray slurry comprising the active substance, with the surface of the plant or, by reducing the surface tension, improves the penetration of the application form and accordingly of the active substance into the soil. Whether a particular surface-active substance acts as adjuvant, i.e. an increase in effect or selectivity is achieved by it, also frequently depends on the type of the active substance.

Since electrolyte-sensitive thickeners are used in the gel formulation according to the invention, it is preferable to use nonionic compounds as adjuvants.

The at least one adjuvant is accordingly preferably chosen from polyether compounds exhibiting repeat units derived from alkylene oxides (e.g., ethylene oxide, propylene oxide, butylene oxide), alkylpolyglycosides, alkoxylated fatty acid esters of polyhydroxyl compounds and mixtures of the abovementioned products.

Suitable polyether compounds typically exhibit at least one, e.g. 1, 2, 3 or 4, polyether groups exhibiting, in addition to the repeat units derived from ethylene oxide, optionally additional repeat units generally derived from C₃-C₈-alkylene oxides and/or styrene oxide. The polyether groups are subsequently also described as macrogol part. In the polyether compounds, the polyether groups are generally covalently bonded to an organic radical (base part) or connected via an ether oxygen atom to a macromolecule. The base part is typically an organic radical with generally from 4 to 40, frequently from 6 to 30 and in particular from 10 to 22 carbon atoms, it being possible for the base part optionally to even exhibit one or more functional groups, e.g. 1 or 2 carbonyloxy groups (C(═O)—O groups) and/or 1, 2, 3 or 4 OH groups and/or 1, 2, 3, 4, 5 or 6 nitrogen atoms. Examples of radicals suitable as base part are C₈-C₃₀-alkyl, C₈-C₃₀-alkenyl, C₄-C₃₀-alkanediyl, C₈-C₃₀-alkanetriyl, C₅-C₁₀-cycloalkyl, C₅-C₁₀-cycloalkanediyl, α,α′-[bisphenyl-C₁-C₄-alkane]diyl, α,α′-[biscyclohexyl-C₁-C₄-alkane]diyl, mono- and di(C₄-C₂₀-alkyl)phenyl, in particular butylphenyl, 4-tert-butylphenyl, hexylphenyl, octylphenyl, nonylphenyl, dodecylphenyl or tridecylphenyl, C₈-C₂₀-alkylcarbonyl, benzoyl, C₁-C₂₀-alkylbenzoyl, naphthyl, which can optionally exhibit 1, 2 or 3 C₁-C₁₀-alkyl groups, mono-, di- and tristyrylphenyl and also radicals derived from sorbitan esters, from alkylpolyglycosides, from mono- or diglycerides and from (oligo)alkylenimines.

Alkyl(poly)glycosides or alkylpolyglucosides are to be understood as meaning compounds exhibiting one or more, in particular one, alkyl radical, in particular one C₆-C₂₂-alkyl radical, bonded via an oxygen atom to a mono- or oligosaccharide radical, e.g. to a mono-, di- or trisaccharide radical. The saccharide units are in this connection typically derived from glucose. Preferred alkyl(poly)glycosides are those exhibiting on average from 1 to 2 glucose units. Mixtures are generally involved in this connection. In polyether compounds exhibiting a base part derived from alkyl(poly)glycosides, the at least one macrogol part replaces at least one of the nonesterified hydroxyl groups of the mono- or oligosaccharide radical.

The ethoxylated fatty acid esters of polyhydroxyl compounds are generally ethoxylates of mono-, di- or triesters of fatty acids with aliphatic or cycloaliphatic polyhydroxyl compounds generally exhibiting 3, 4, 5 or 6 hydroxyl groups and 3, 4, 5 or 6 carbon atoms, the nonethoxylated esters of the fatty acids with polyhydroxyl compounds generally still exhibiting at least one, preferably 2, 3 or 4, free hydroxyl groups. The fatty acid constituents in these substances are generally derived from saturated, monounsaturated or polyunsaturated fatty acids, the fatty acids generally exhibiting from 6 to 22 and in particular from 8 to 18 carbon atoms. Examples of suitable fatty acid constituents in these substances are radicals derived from saturated fatty acids, such as lauric acid, myristic acid, palmitic acid, margaric acid, stearic acid, arachic acid, behenic acid, lignoceric acid and cerotic acid, from unsaturated fatty acids, such as undecylenic acid, palmitoleic acid, oleic acid, elaidic acid, vaccenic acid, icosenoic acid, cetoleic acid, erucic acid and nervonic acid, and derived from polyunsaturated fatty acids, such as linoleic acid, α-linolenic acid, γ-linolenic acid, arachidonic acid, timnodonic acid, clupanodonic acid and cervonic acid. The fatty acid constituents can also be derived from mixtures of the abovementioned fatty acids.

Preferred polyether compounds are chosen from polyethoxylates and poly(ethoxylate-co-propoxylate)s of C₈-C₂₂-alkanols, polyethoxylates and poly(ethoxylate-co-propoxylate)s of fatty acids, polyethoxylates and poly(ethoxylate-co-propoxylate)s of fatty amines, polyethoxylates and poly(ethoxylate-co-propoxylate)s of mono- and diglycerides of aliphatic C₈-C₂₂-monocarboxylic acids, polyethoxylates and poly(ethoxylate-co-propoxylate)s of sorbitan esters of aliphatic C₈-C₂₂-monocarboxylic acids, polyethoxylates and poly(ethoxylate-co-propoxylate)s of alkylphenols, polyethoxylates and poly(ethoxylate-co-propoxylate)s of di- and tristyrylphenols, polyethoxylates and poly(ethoxylate-co-propoxylate)s of alkylpolyglycosides and mixtures thereof.

The molecular weight of the polyether compounds can vary over a wide range and is typically in the range from 200 to 10 000 daltons and in particular in the range from 300 to 5000 daltons (in each case number-average molecular weight Mₙ), unless otherwise given. The ratio of weight-average molecular weight to number-average molecular weight M_{w}/Mₙ is preferably in the range from 0.9 to 1.6, preferably in the range from 1.0 to 1.4 and particularly preferably in the range from 1.1 to 1.3.

Preferred ethoxylated fatty acid esters of polyhydroxyl compounds are ethoxylated fatty acid monoesters of glycerol and also ethoxylated fatty acid mono- and diesters of sorbitan or of sorbitan anhydride, the fatty acid radicals in these compounds preferably exhibiting from 8 to 20 and in particular from 10 to 18 carbon atoms. The fatty acid radicals can be saturated or mono- or polyunsaturated and are typically derived from the abovementioned fatty acids and the mixtures thereof, in particular from lauric acid, myristic acid, palmitic acid, margaric acid, stearic acid, palmitoleic acid, oleic acid, linoleic acid and the mixtures thereof.

The degree of ethoxylation, i.e. the mean number of repeat units derived from ethylene oxide, is typically from 5 to 50 and in particular from 10 to 40.

The abovementioned adjuvants are in some cases used in combination with additional auxiliaries which improve their mode of action or broaden their spectrum of activities. Standard supplementary auxiliaries are, for example, organic solvents, which further improve the spreading on the surface of the plants. Suitable solvents are, for example, aliphatic and in particular aromatic solvents, such as toluene, the xylenes and the Solvesso and naphtha products.

As a rule, plant protection agents and adjuvants are not generally incompatible but for the most part are only incompatible if the adjuvant is used in a relatively large amount. To be exact, if its concentration in an aqueous disperse phase exceeds a limiting value, the adjuvant can represent a solvent for the plant protection agent which is sparingly soluble or insoluble in water. At the same time, however, its concentration is nevertheless so low that the plant protection agent is present in the adjuvant in saturated or supersaturated form. Ostwald ripening then results in a growth in size of the larger crystals at the expense of the smaller crystals in the formulation. If this process goes on long enough in the formulation, this can result in stability and application problems with the plant protection agent products. The concentration of the adjuvant resulting in an unacceptable degree of Ostwald ripening of the plant protection agent depends on the individual plant protection agent, on its own concentration, on the adjuvant used and on the type and concentration of other components, such as dispersing agents and other auxiliaries. However, type and concentration of individual adjuvants, which in the combined formulation with specific plant protection agents in the aqueous phase result in the formation of a precipitate, are frequently known to a person skilled in the art at formulating or result from formulation tests.

Specific examples of incompatible substances A and B may be mentioned by way of illustration:

| Substance A | Substance B |
|---|---|
| Dithianon | Pyrimethanil |
| Epoxiconazole/ | C₁₆/C₁₈-alcohol alkoxylated with 2-10 mol of |
| Dimoxystrobin | ethylene oxide and 5-10 mol of propylene oxide |
| Terbuthylazine | Dimethenamid |

The at least one plant protection agent is present in the gel-form phase, in which it is present in a total amount of preferably from 2 to 60% by weight, particularly preferably of 5 to 50% by weight and in particular from 10 to 40% by weight, based on the total weight of the phase.

The at least one adjuvant is present in the gel-form phase, in which it is present in a total amount of preferably from 2 to 50% by weight, particularly preferably of 5 to 40% by weight and in particular from 10 to 30% by weight, based on the total weight of the phase. Due to the embedding in a gel, the adjuvant can be present in the gel formulation according to the invention in markedly greater amounts than is possible in conventional liquid formulations.

Since the gel formulation according to the invention is water-based, the at least one electrolyte-sensitive thickener is preferably chosen from those which are suitable for the thickening of aqueous systems.

In principle, those thickeners are electrolyte-sensitive which comprise groups which can dissociate to give ions, i.e. which represent polyelectrolytes. Polyelectrolytes are subdivided, depending on the type of the groups which can dissociate to give ions, into polyacids and polybases. Examples of characteristic repeating units of polyacids are polyphosphoric acid (—O—P(O)(OH)—), vinyl sulfuric acid units (—CH₂—CH(OSO₃H)—), vinylsulfonic acid units (—CH₂—CH(SO₃H)—), vinylphosphonic acid units (—CH₂—CH(PO(OH)₂)—) and acrylic acid or methacrylic acid units (—CH₂—CH(COOH)— or —CH₂—C(CH₃)(COOH)—). Polybases generally comprise imine units (—NH—), amine units (e.g., vinylamine units, such as —CH₂—CH(NH₂)—) or nitrogenous heterocyclic units, such as vinylpyridine units. The dissociation through proton separation of polyacids results in polyanions, while polybases can react by taking up protons to give polycations. Polyelectrolytes comprising both cationic and anionic groups are described as polyampholytes.

The electrolyte-sensitive thickener is preferably neither a natural thickener (these include products such as agar, carrageen, gum tragacanth, gum arabic, alginates, pectinates, polyoses, guar flour, locust bean flour, starch, dextrins, gelatins, casein) nor a modified natural substance (these include cellulose ethers, such as carboxymethyl-cellulose, furthermore hydroxyethyl- and hydroxypropylcellulose and the like). The electrolyte-sensitive thickener is preferably an organic thickener which is completely synthetic.

The organic thickener which is completely synthetic is preferably chosen in this connection from polyacrylic acids and/or polyacrylates with a number-average molecular weight of 1×10³ to 1×10⁹, homo- or copolymers of acrylamide and/or methacrylamide with a number-average molecular weight of 1×10³ to 1×10⁹ and ethylene/maleic anhydride copolymers with a number-average molecular weight of 1×10³ to 1×10⁹; particularly preferably from homo- or copolymers of acrylamide and/or methacrylamide with a number-average molecular weight of 1×10³ to 1×10⁹ and very preferably from copolymers of acrylamide and/or methacrylamide with a number-average molecular weight of 1×10³ to 1×10⁹.

The at least one electrolyte-sensitive thickener is very preferably chosen from polymers obtainable by radical copolymerization of
A) acryloyldimethyltaurine (2-acrylamido-2-methyl-1-propanesulfonic acid; acrylamidopropylmethylenesulfonic acid; AMPS®) and/or salts thereof;
B) one or more macromonomers comprising
   a) an end group capable of polymerizing, which is at least partially soluble in the reaction medium,
   b) a hydrophobic part, which represents hydrogen or a saturated or unsaturated and linear or branched aliphatic, cycloaliphatic or aromatic C₁-C₁₀₀-hydrocarbon radical, and
   c) optionally a hydrophilic part, which is based on polyalkylene oxides; and
C) optionally one or more additional at least monoolefinically or polyolefinically unsaturated comonomers comprising oxygen, nitrogen, sulfur, phosphorus, chlorine and/or fluorine.

Such copolymers are known in principle and are described, for example, in DE-A-10163888, reference to which is made herewith in its entirety.

Preferably, the macromonomers B) comprise a hydrophilic part based on polyalkylene oxides, preferably polyethylene oxides and/or polypropylene oxides.

Preferably suitable as salts of acrylamidopropylmethylenesulfonic acid (AMPS) are the lithium, sodium, potassium, magnesium, calcium, ammonium, monoalkylammonium, dialkylammonium, trialkylammonium or tetraalkylammonium salts, the alkyl substituents of the ammonium ions representing, independently of one another, (C₁-C₂₂)-alkyl radicals which can be studded with from 0 to 3 hydroxyalkyl groups, the alkyl chain length of which can vary within a range from C₂ to C₁₀. Mono- to triethoxylated ammonium compounds with a different degree of ethoxylation are likewise suitable. Particular preference is given, as salts, to the sodium and ammonium salts.

The degree of neutralization of the acrylamidopropylmethylenesulfonic acid (AMPS) is preferably from 70 to 100 mol %.

The comonomers A) are preferably the sodium and/or ammonium salts of acrylamidopropylmethylenesulfonic acid (AMPS).

Preferred macromonomers B) are further described below under (f).

In a preferred embodiment, the polymers comprise yet further olefinically unsaturated comonomers C) comprising oxygen, nitrogen, sulfur, phosphorus, chlorine and/or fluorine.

Preference is given, as comonomers C), to olefinically unsaturated acids or the salts thereof, preferably with a mono- and divalent counterions, particularly preferably styrenesulfonic acid, vinylsulfonic acid, vinylphosphonic acid, allylsulfonic acid, methallylsulfonic acid, acrylic acid, methacrylic acid and/or maleic acid or maleic anhydride, fumaric acid, crotonic acid, itaconic acid or senecioic acid or the salts thereof. Preferred counterions are Li⁺, Na⁺, K⁺, Mg²⁺, Ca²⁺, Al³⁺, NH₄₊, monoalkylammonium, dialkylammonium, trialkylammonium and tetraalkylammonium ions, in which the substituents of the amines represent, independently of one another, C₁-C₂₂-alkyl radicals which can be studded with from 0 to 3 hydroxyalkyl groups, the alkyl chain length of which can vary within the range from C₂ to C₁₀. Use may in addition also be made of mono- to triethoxylated ammonium compounds with a different degree of ethoxylation, and also corresponding acid anhydrides (also mixed). The degree of neutralization of the optional olefinically unsaturated acids C) can be from 0 to 100%, preferably from 70 to 100%.

Furthermore suitable as comonomers C) are esters of unsaturated carboxylic acids, preferably acrylic acid, methacrylic acid, styrenesulfonic acid, maleic acid, fumaric acid, crotonic acid and senecioic acid, with aliphatic or aromatic or cycloaliphatic alcohols with a carbon number of 1 to 30.

Comonomers C) which are likewise suitable are acyclic and cyclic N-vinylamides (N-vinyllactams) with a ring size of 4 to 9 atoms, preferably N-vinylformamide (NVF), N-vinylmethylformamide, N-vinylmethylacetamide (VIMA), N-vinylacetamide, N-vinylpyrrolidone (NVP) or N-vinylcaprolactam; amides of acrylic acid and methacrylic acid, particularly preferably acrylamide, N,N-dimethylacrylamide, N,N-diethylacrylamide or N,N-diisopropylacrylamide; or alkoxylated acrylamides and methacrylamides, preferably hydroxymethylmethacrylamide, hydroxyethylmethacrylamide and hydroxypropylmethacrylamide.

Likewise suitable are succinic acid mono[2-(methacryloyloxy)ethyl] ester; N,N-dimethylamino methacrylate; diethylaminomethyl methacrylate; acrylamidoglycolic acid and methacrylamidoglycolic acid; [2-(methacryloyloxy)ethyl]trimethylammonium chloride (MAPTAC) and [2-(acryloyloxy)ethyl]trimethylammonium chloride (APTAC); 2-vinylpyridine; 4-vinylpyridine; vinyl acetate; methacrylic acid glycidyl ester; acrylonitrile; vinyl chloride; vinylidene chloride; diallyldimethylammonium chloride (DADMAC); stearyl acrylate; lauryl methacrylate; and/or tetrafluoroethylene.

Also suitable are methylenebisacrylamide and methylenebismethacrylamide; esters of unsaturated mono- and polycarboxylic acids with polyols, e.g. diacrylates or triacrylates, such as butanediol diacrylate or dimethacrylate, ethylene glycol diacrylate or dimethacrylate, and trimethylolpropane triacrylate; allyl compounds, e.g. allyl (meth)acrylate, triallyl cyanurate, diallyl maleate, polyallyl esters, tetraallyloxyethane, triallylamine, tetraallylethylenediamine, or allyl esters of phosphoric acid; and/or vinylphosphonic acid derivatives.

Particular preference is given, for the use, to polymers which can be prepared by radical copolymerization of A) acrylamidopropylmethylenesulfonic acid (AMPS), the sodium salt of acrylamidopropylmethylenesulfonic acid (AMPS) and/or the ammonium salt of acrylamidopropylmethylenesulfonic acid, preferably the ammonium salt of acrylamidopropylmethylenesulfonic acid (AMPS); B) one or more macromonomers chosen from the group of the esters formed from methacrylic acid or acrylic acid, preferably methacrylic acid, and compounds of the following formula

HO—(CH₂—CH₂—O)ₓ—R³

in which
x is a number between 0 and 50, preferably between 1 and 50, particularly preferably between 5 and 30; and
R³ is a C₁₀-C₂₂-alkyl radical;
   and C) optionally one or more comonomers chosen from the group consisting of acrylamide, vinylformamide, N-vinylmethylacetamide, sodium methallylsulfonate, hydroxyethyl methacrylate, acrylic acid, methacrylic acid, maleic anhydride, methacrylamide, vinyl acetate, N-vinylpyrrolidone, vinylphosphonic acid, styrene, styrenesulfonate (sodium salt), t-butyl acrylate and methyl methacrylate, preferably methacrylic acid and/or methacrylamide.

Particularly suitable as macromonomers B) are esters formed from acrylic acid or methacrylic acid and alkyl ethoxylates chosen from the group
C₁₀-C₁₈-fatty alcohol polyglycol ethers with 8 EO units (Genapol® C-080);
C₁₁-oxo-alcohol polyglycol ethers with 8 EO units (Genapol® UD-080);
C₁₂-C₁₄-fatty alcohol polyglycol ethers with 7 EO units (Genapol® LA-070);
C₁₂-C₁₄-fatty alcohol polyglycol ethers with 11 EO units (Genapol® LA-110);
C₁₆-C₁₈-fatty alcohol polyglycol ethers with 8 EO units (Genapol® T-080);
C₁₆-C₁₈-fatty alcohol polyglycol ethers with 15 EO units (Genapol® T-150);
C₁₆-C₁₈-fatty alcohol polyglycol ethers with 11 EO units (Genapol® T-110);
C₁₆-C₁₈-fatty alcohol polyglycol ethers with 20 EO units (Genapol® T-200);
C₁₆-C₁₈-fatty alcohol polyglycol ethers with 25 EO units (Genapol® T-250);
C₁₈-C₂₂-fatty alcohol polyglycol ethers with 25 EO units;
iso-C₁₆-C₁₈-fatty alcohol polyglycol ethers with 25 EO units; and
C₂₂-fatty alcohol polyglycol ethers with 25 EO units (Mergital® B25).

In this connection, the EO units are ethylene oxide units. The Genapol® grades are products from Clariant and Mergital® B25 is a product from Cognis.

Particular preference is likewise given to polymers which can be prepared by radical copolymerization of A) acrylamidopropylmethylenesulfonic acid (AMPS), the sodium salt of acrylamidopropylmethylenesulfonic acid (AMPS) and/or the ammonium salt of acrylamidopropylmethylenesulfonic acid, preferably the ammonium salt of acrylamidopropylmethylenesulfonic acid (AMPS); B) one or more macromonomers chosen from the group of the esters formed from acrylic acid or methacrylic acid, preferably methacrylic acid, and compounds of the following formula

HO—(CH₂—CH₂—O)ₓ—R³

in which
x is a number between 0 and 50, preferably between 1 and 50, particularly preferably between 5 and 30, and
R³ is a poly(C₁-C₂₂-alkyl)phenyl radical, preferably a tris(sec-butyl)phenyl radical or a tris(n-butyl)phenyl radical, particularly preferably a 2,4,6-tris(sec-butyl)phenyl radical, or a tris(styryl)phenyl radical, in particular a 2,4,6-tris(1-phenylethyl)phenyl radical;
   and C) optionally one or more comonomers chosen from acrylamide, N-vinylformamide, N-vinylmethylacetamide and sodium methallylsulfonate, hydroxyethyl methacrylate, acrylic acid, methacrylic acid, maleic anhydride, methacrylamide, vinyl acetate, N-vinylpyrrolidone, vinylphosphonic acid, styrene, styrenesulfonate (sodium salt), tert-butyl acrylate or methyl methacrylate, preferably methacrylic acid and/or methacrylamide.

The proportion by weight of the macromonomers B) in the polymer can vary between 0.1 and 99.9% by weight. In a preferred embodiment, the polymers are highly hydrophobically modified, i.e. the proportion of macromonomers B) is from 50.1 to 99.9% by weight, preferably from 70 to 95% by weight, particularly preferably from 80 to 94% by weight. In an additional preferred embodiment, the polymers are poorly hydrophobically modified, i.e. the proportion of macromonomers B) is from 0.1 to 50% by weight, preferably from 5 to 25% by weight, particularly preferably from 6 to 20% by weight.

The monomer distribution of the monomers A), B) and C) in the polymers can be alternating, random, gradient or block (also multiblock). The number-average molecular weight of the polymers is preferably from 1000 to 20 000 000 g/mol, preferably from 20 000 to 5 000 000 g/mol, particularly preferably from 50 000 to 1 500 000 g/mol.

In a preferred embodiment, the polymers are crosslinked, i.e. at least one crosslinking agent with at least two double bonds is copolymerized in the polymer.

Preferred crosslinking agents are methylenebisacrylamide and methylenebismethacrylamide; esters of unsaturated mono- or polycarboxylic acids with polyols, preferably diacrylates and triacrylates, e.g. butanediol diacrylate or dimethacrylate, ethylene glycol diacrylate or dimethacrylate, and trimethylolpropane triacrylate, allyl compounds, preferably allyl (meth)acrylate, triallyl cyanurate, diallyl maleate, polyallyl esters, tetraallyloxyethane, triallylamine, tetraallylethylenediamine, allyl esters of phosphoric acid; and/or vinylphosphonic acid derivatives.

The polymers can be prepared by radical copolymerization, e.g. precipitation polymerization, emulsion polymerization, solution polymerization or suspension polymerization. Particularly suitable are polymers prepared by precipitation polymerization, preferably in tert-butanol. By the use of precipitation polymerization in tert-butanol, a specific particle size distribution of the polymers can be achieved in comparison with other solvents. The size distribution of the polymer particles can be determined, e.g., by laser diffraction or sieve analysis. The following particle size distribution is representative of a convenient size distribution, the particle size distribution being, as was determined by sieve analysis: 60.2% less than 423 micrometers, 52.0% less than 212 micrometers, 26.6% less than 106 micrometers, 2.6% less than 45 micrometers and 26.6% greater than 850 micrometers.

In particular, the at least one electrolyte-sensitive thickener is chosen from copolymers of
(a) acryloyldimethyltaurine (2-acrylamido-2-methyl-1-propanesulfonic acid; acrylamidopropylmethylenesulfonic acid; AMPS) and/or salts thereof with
(b) at least one olefinically unsaturated, noncationic, optionally crosslinking and optionally heat-sensitive comonomer exhibiting at least one oxygen, nitrogen, sulfur or phosphorus atom and having a molecular weight of at most 500; and/or
(c) at least one olefinically unsaturated cationic comonomer exhibiting at least one oxygen, nitrogen, sulfur or phosphorus atom and having a molecular weight of at most 500; and/or
(d) at least one olefinically unsaturated silicon-comprising comonomer; and/or
(e) at least one olefinically unsaturated fluorine-comprising comonomer; and/or
(f) at least one optionally heat-sensitive macromer having a number-average molecular weight of at least 200; and/or
(g) at least one polymer additive with a number-average molecular weight of 200 to 1×10⁹.

In this connection, the proviso applies that component (a) is copolymerized with at least one of the components (b) to (g).

Such polymers are known in principle and are described, for example, in WO 02/44230.

The copolymers preferably have a molecular weight of 10³ g/mol to 10⁹ g/mol, particularly preferably of 10⁴ to 10⁷ g/mol, especially preferably of 5×10⁴ to 5×10⁶ g/mol.

The salts of acryloyldimethyltaurine can be the inorganic or organic salts. Preference is given to the Li⁺, Na⁺, K⁺, Mg²⁺, Ca²⁺, Al³⁺ and/or NH₄⁺ salts. Preference is likewise given to the monoalkylammonium, dialkylammonium, trialkylammonium and/or tetraalkylammonium salts, it being possible for the alkyl substituents of the amines to be, independently of one another, C₁-C₂₂-alkyl radicals which can optionally be studded with up to three hydroxy-C₂-C₁₀-alkyl groups. Furthermore, preference is also given to mono- to triethoxylated ammonium compounds with a different degree of ethoxylation. It should be noted that mixtures of two or more of the abovementioned representatives or the free acryloyldimethyltaurine also come within the meaning of the invention.

The degree of neutralization of the acryloyldimethyltaurine in the copolymers can be between 0 and 100%. Particular preference is given to a degree of neutralization of greater than 80%.

The content of acryloyldimethyltaurine or acryloyldimethyltaurates, based on the total weight of the copolymers, can be from 0.1 to 99.9% by weight, preferably from 20 to 99.5% by weight, particularly preferably from 50 to 98% by weight.

Use may be made, as comonomers (b), of all olefinically unsaturated and noncationic monomers, the reaction parameters of which make possible a copolymerization with acryloyldimethyltaurine and/or acryloyldimethyltaurates in the respective reaction media. Preference is given to unsaturated carboxylic acids and anhydrides and salts thereof and also the esters thereof with aliphatic, olefinic, cycloaliphatic, arylaliphatic or aromatic alcohols with a carbon number of 1 to 22. Particular preference is given, as unsaturated carboxylic acids, to acrylic acid, methacrylic acid, styrenesulfonic acid, maleic acid, fumaric acid, crotonic acid, itaconic acid and senecioic acid. Preference is furthermore given to acyclic N-vinylamides, preferably N-vinylformamide (VIFA), N-vinylmethylformamide, N-vinylmethylacetamide (VIMA) and N-vinylacetamide; cyclic N-vinylamides (N-vinyllactams) with a ring size of 3 to 9, preferably N-vinylpyrrolidone (NVP) and N-vinylcaprolactam; amides of acrylic acid and methacrylic acid, preferably acrylamide, methacrylamide, N,N-dimethylacrylamide, N,N-diethylacrylamide and N,N-diisopropylacrylamide; alkoxylated acrylamides and methacrylamides, preferably hydroxymethylacrylamide, hydroxyethylacrylamide, hydroxypropylacrylamide, hydroxymethylmethacrylamide, hydroxyethylmethacrylamide and hydroxypropylmethacrylamide; succinic acid mono[2-(methacryloyloxy)ethyl] ester; N,N-dimethylamino methacrylate; diethylaminomethyl methacrylate; acrylamidoglycolic acid and methacrylamidoglycolic acid; 2- and 4-vinylpyridine; vinyl acetate; methacrylic acid glycidyl ester; styrene; acrylonitrile; vinyl chloride; stearyl acrylate; lauryl methacrylate; vinylidene chloride; and/or tetrafluoroethylene. Likewise suitable are inorganic acids and the salts and esters thereof. Preferred acids are vinylphosphonic acid, vinylsulfonic acid, allylphosphonic acid and methallylsulfonic acid. That said above is valid with regard to suitable salts.

Examples of comonomers (b) are: N,N-diisopropylacrylamide, N-vinylpyrrolidone (NVP), methacrylic acid, vinyl acetate and vinyl alcohol.

In an additional preferred embodiment, the copolymers are crosslinked, i.e. they comprise comonomers (b) with at least two polymerizable vinyl groups. Preferred crosslinking agents are methylenebisacrylamide; methylenebismethacrylamide; esters of unsaturated mono- and polycarboxylic acids with polyols, preferably diacrylates and triacrylates or dimethacrylates and trimethacrylates, particularly preferably butanediol diacrylate or dimethacrylate, ethylene glycol diacrylate or dimethacrylate, trimethylolpropane triacrylate (TMPTA) and trimethylolpropane trimethacrylate (TMPTMA); allyl compounds, preferably allyl (meth)acrylate, triallyl cyanurate, diallyl maleate, polyallyl esters, tetraallyloxyethane, triallylamine, tetraallylethylenediamine; allyl esters of phosphoric acid; and/or vinylphosphonic acid derivatives. Particular preference is given, as crosslinking agent, to trimethylolpropane triacrylate (TMPTA).

The proportion by weight of the comonomers (b), based on the total weight of the copolymers, can be from 0 to 99.9% by weight and is preferably from 0.05 to 80% by weight, particularly preferably from 0.05 to 70% by weight.

Possible comonomers (c) are all olefinically unsaturated monomers with a cationic charge which are able, in the chosen reaction media, to form copolymers with acryloyldimethyltaurine or the salts thereof. The distribution of the cationic charges over the chains which results in this connection can be random, alternating, block or gradient. It should be pointed out that the cationic comonomers (c) are also to be understood as including those which carry the cationic charge in the form of a betaine structure. Comonomers (c) within the meaning of the invention are also amino-functionalized precursors which can be converted to their corresponding quaternary derivatives by polymer-analogous reactions (e.g., reaction with DMS). Particular preference is given, as comonomers (c), to diallyldimethylammonium chloride (DADMAC), [2-(methacryloyloxy)ethyl]trimethylammonium chloride (MAPTAC), [2-(acryloyloxy)ethyl]trimethylammonium chloride, [2-(methacrylamido)ethyl]trimethylammonium chloride, [2-(acrylamido)ethyl]trimethylammonium chloride, N-methyl-2-vinylpyridinium chloride and/or N-methyl-4-vinylpyridinium chloride.

The proportion by weight of the comonomers (c), based on the total weight of the copolymers, is preferably from 0.1 to 99.8% by weight, particularly preferably from 0.5 to 30% by weight and especially preferably from 1 to 20% by weight.

Suitable as polymerizable silicon-comprising components (d) are all at least monoolefinically unsaturated compounds capable of radical copolymerization under the reaction conditions chosen each time. In this connection, the distribution of the individual silicone-comprising monomers over the polymer chains produced does not necessarily have to take place randomly. The formation of, for example, block (even multiblock) or gradient structures is also suitable. Combinations of two or more different silicone-comprising representatives are also possible. The use of silicone-comprising components with two or more polymerization-active groups results in the construction of branched or crosslinked structures. Preferred silicon-comprising components (d) are those according to the following formula

R¹—Y—[(Si(R³R⁴)—O—)_{w}—(Si(R⁵R⁶)—O)ₓ—]—R²

in which
R¹ is an olefinically unsaturated group, preferably a vinyl, allyl, methallyl, methylvinyl, acryloyl, methacryloyl, crotonyl, senecionyl, itaconyl, maleinyl, fumaryl or styryl radical, particularly preferably an acryloyl or methacryloyl radical;
Y is a bridging member, preferably —O—, —C(O)—, —C(O)—O—, —S—, —O—CH₂—CH(O—)—CH₂OH, —O—CH₂—CH (OH)—CH₂—O, —O—SO₂—O—, —O—S(O)—O—, —PH—, —P(CH₃)—, —PO₃—, —NH—, —N(CH₃)—, —O—(C₁-C₅₀-alkyl)—O—, —O-phenyl-O—, —O-benzyl-O—, —O—(C₅-C₈-cycloalkyl)-O—, —O—(C₁-C₅₀-alkenyl)-O—, —O—(CH(CH₃)—CH₂—O)ₙ—, —O—(CH₂—CH₂—O)ₙ—, —O—([CH(CH₃)—CH₂—O]ₙ—[CH₂—CH₂—O]ₘ)ₒ—, n, m and o representing, independently of one another, numbers from 0 to 200 and it being possible for the distribution of the ethylene oxide units (CH₂—CH₂—O) and propylene oxide units (CH(CH₃)—CH₂—O) to be random or block;
R³, R⁴, R⁵ and R⁶ are, independently of one another, CH₃, OCH₃, C₆H₅ or OC₆H₅;
w and x are stoichiometric coefficients which are, independently of one another, from 0 to 500, preferably from 10 to 250; and
R² is a linear or branched aliphatic, olefinic, cycloaliphatic, arylaliphatic or aromatic C₁-C₅₀-hydrocarbon radical or is —OH, —NH₂, —N(CH₃)₂ or R⁷ or is the structural unit [—Y—R¹], in which Y and R¹ are as defined above and R⁷ is an Si-comprising group, preferably —O—Si(CH₃)₃, —O—Si(Ph)₃, —O—Si(O—Si(CH₃)₃)₂CH₃ or —O—Si(O—Si(Ph)₃)₂Ph.

The distribution of the repeat units over the chain can be not only purely random but also block, alternating or gradient. Formula (I) describes not only vinylically functionalized silicone-comprising polymer entities with a polymer-type distribution but also defined compounds with discrete molecular weights.

If R² represents an element of the group [—Y—R¹], difunctional monomers are concerned which can be used for the crosslinking of the polymer structures produced.

Particular preference is given, as silicon-comprising components (d), to the following acrylically or methacrylically modified compounds:

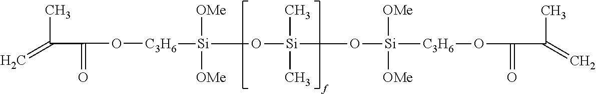

polydimethylsiloxanes end-blocked with methacryloyloxypropyldimethylsilyl with f=10 to 500, preferably 10 to 250;

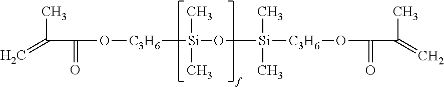

polydimethylsiloxanes end-blocked with methacryloyloxypropyl with f=10 to 500, preferably 10 to 250; and

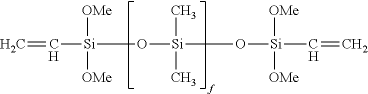

polydimethylsiloxanes end-blocked with vinyldimethoxysilyl with f=10 to 500, preferably 10 to 250.

Suitable silicon-comprising components can be present, based on the total weight of the copolymers, at up to 99.8% by weight, preferably from 0.5 to 30% by weight, particularly preferably from 1 to 20% by weight.

Suitable as polymerizable fluorine-comprising components (e) are all at least monoolefinically unsaturated compounds which are capable of radical copolymerization under the reaction conditions chosen each time. In this connection, the distribution of the individual fluorine-comprising monomers over the polymer chains produced does not necessarily have to take place randomly. The formation of, for example, block (even multiblock) or gradient structures is also suitable. Combinations of two or more different fluorine-comprising components (e) are also possible, it being clear to a person skilled in the art that monofunctional representatives result in the formation of comb-like structures, while di-, tri- or polyfunctional components (e) result in at least partially crosslinked structures. Preferred fluorine-comprising components (e) are those according to the following formula:

R¹—Y—CᵣH₂ᵣCₛF₂ₛCF₃

in which
R′ is an olefinically unsaturated group, preferably a vinyl, allyl, methallyl, methylvinyl, acryloyl, methacryloyl, crotonyl, senecionyl, itaconyl, maleinyl, fumaryl or styryl radical, particularly preferably an acryloyl or methacryloyl radical;
Y is a bridging member, preferably —O—, —C(O)—, —C(O)—O—, —S—, —O—CH₂—CH(O—)—CH₂OH, —O—CH₂—CH (OH)—CH₂—O—, —O—SO₂—O—, —O—S(O)—O—, —PH—, —P(CH₃)—, —PO₃—, —NH—, —N(CH₃)—, —O—(C₁-C₅₀-alkyl)—O—, —O-phenyl-O—, —O-benzyl-O—, —O—(C₅-C₈-cycloalkyl)-O—, —O—(C₁-C₅₀-alkenyl)-O—, —O—(CH(CH₃)—CH₂—O—)ₙ—, —O—(CH₂—CH₂—O)ₙ—, —O—([CH(CH₃)—CH₂—O]ₙ—[CH₂—CH₂—O]ₘ)ₒ—, n, m and o representing, independently of one another, numbers from 0 to 200 and it being possible for the distribution of the ethylene oxide units (CH₂—CH₂—O) and propylene oxide units (CH(CH₃)—CH₂—O) to be random or block; and
r and s are stoichiometric coefficients which are, independently of one another, from 0 to 200.

Preferred fluorine-comprising components (e) according to the above formula are perfluorohexylethanol methacrylate, perfluorohexylpropanol methacrylate, perfluorooctylethanol methacrylate, perfluorooctylpropanol methacrylate, perfluorohexylethanolyl polyglycol ether methacrylate, perfluorohexylpropanolyl poly[ethylene glycol-co-propylene glycol ether] acrylate, perfluorooctylethanolyl poly[ethylene glycol-block-co-propylene glycol ether] methacrylate, perfluorooctylpropanolyl polypropylene glycol ether methacrylate.

The proportion of fluorine-comprising components, based on the total weight of the copolymers, can be up to 99.8% by weight, preferably from 0.5 to 30% by weight, particularly preferably from 1 to 20% by weight.

The macromonomers (f) are at least monoolefinically functionalized polymers with one or more discrete repeat units and a number-average molecular weight of greater than or equal to 200 g/mol. Use may also be made, in the copolymerization, of mixtures of chemically different macromonomers (f). The macromonomers are polymer structures which are synthesized from one or more repeat unit(s) and which exhibit a molecular weight distribution characteristic of polymers. Preference is given, as macromonomers (f), to compounds according to the following formula:

R¹—Y—[(A)ᵥ-(B)_{w}—(C)ₓ-(D)_{z}]-R²

in which
R¹ is an olefinically unsaturated group, preferably a vinyl, allyl, methallyl, methylvinyl, acryloyl, methacryloyl, crotonyl, senecionyl, itaconyl, maleinyl, fumaryl or styryl radical;
Y is a bridging member, preferably —O—, —C(O)—, —C(O)—O—, —S—, —O—CH₂—CH(O)—CH₂OH, —O—CH₂—CH(OH)—CH₂—O—, —O—SO₂—O—, —O—S(O)—O—, —PH—, —P(CH₃)—, —PO₃—, —NH— and —N(CH₃)—, preferably —O—;
A, B, C and D are repeat units and are preferably derived from acrylamide, methacrylamide, ethylene oxide, propylene oxide, AMPS, acrylic acid, methacrylic acid, methyl methacrylate, acrylonitrile, maleic acid, vinyl acetate (vinyl alcohol), N-vinylpyrrolidinone, N-vinylcaprolactam, styrene, 1,3-butadiene, isoprene, isobutene, diethylacrylamide or diisopropylacrylamide;
v, w, x and z are stoichiometric coefficients which are, independently of one another, from 0 to 500, preferably from 1 to 30, the sum of the four coefficients being on average ≧1; and
R² is a linear or branched aliphatic, olefinic, cycloaliphatic, arylaliphatic or aromatic C₁-C₅₀-hydrocarbon radical or is —OH, —NH₂ or —N(CH₃)₂ or is the structural unit [—Y—R¹], Y and R¹ being as defined above.

The distribution of the repeat units over the macromonomer chain can be random, block, alternating or gradient.

If R² represents an element of the group [—Y—R¹], difunctional macromonomers are concerned which are suitable for the crosslinking of the copolymers.

Particular preference is given, as macromonomers (f), to acrylically or methacrylically monofunctionalized alkyl ethoxylates according to the following formula:

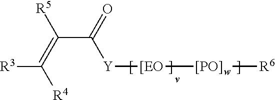

in which
R³, R⁴, R⁵ and R⁶ are, independently of one another, hydrogen or n-aliphatic, isoaliphatic, olefinic, cycloaliphatic, arylaliphatic or aromatic C₁-C₃₀-hydrocarbon radicals;
Y is one of the abovementioned bridging members; and
v and w are stoichiometric coefficients concerning the ethylene oxide units (EO) and propylene oxide units (PO) and are, independently of one another, from 0 to 500, preferably from 1 to 30, the sum of v and w being on average 1.

Preferably, R³ and R⁴ are H or CH₃, particularly preferably H; R⁵ is preferably H or CH₃; and R⁶ is preferably an n-aliphatic, isoaliphatic, olefinic, cycloaliphatic, arylaliphatic or aromatic C₁-C₃₀-hydrocarbon radical.

Preferably, the molecular weight of the macromonomers (f) is from 200 g/mol to 10⁶ g/mol, particularly preferably from 200 to 10⁶g/mol and especially preferably from 200 to 10 000 g/mol.

Suitable macromonomers may be present in a proportion of up to 99.8% by weight, based on the total weight of the copolymers. Use is preferably made of the ranges from 0.5 to 30% by weight and from 70 to 99.5% by weight. Proportions of 1 to 20% by weight and 65 to 95% by weight are particularly preferred.

The distribution of the EO and PO units over the macromonomer chain can be random, block, alternating or gradient.

In one embodiment, the copolymerization is carried out in the presence of at least one polymer additive (g), it being possible for the additive (g) to be added completely or partially dissolved to the polymerization medium before the actual copolymerization. The use of several additives (g) is likewise suitable. Crosslinked additives (g) can likewise be used. The additives (g) or the mixtures thereof simply have to be completely or partially soluble in the polymerization medium chosen. The additive (g) has several functions during the actual polymerization step. On the one hand, it prevents in the actual polymerization step the formation of excessively crosslinked polymer moieties in the copolymer being formed and, on the other hand, the additive (g) is randomly attacked by active radicals according to the generally known mechanism of graft copolymerization. The result of this is that, depending on the additive (g), greater or lesser proportions thereof are incorporated in the copolymers. In addition, suitable additives (g) have the property of changing the dissolution parameters of the copolymers being formed during the radical polymerization reaction in such a way that the mean molecular weights are shifted to higher values. Compared with analogous copolymers prepared without the addition of the additives (g), those prepared with addition of additives (g) advantageously show a significantly higher viscosity in the aqueous solution. Preference is given, as additives (g), to homo- and copolymers which are soluble in water and/or alcohols. Copolymers are in this connection also to be understood as those with more than two different types of monomers. Preference is particularly given, as additives (g), to homo- and copolymers of vinyl acetate, vinyl butyral, vinyl alcohol, N-vinylformamide, N-vinylacetamide, N-vinylpyrrolidone, ethylene oxide, propylene oxide, acryloyldimethyltaurine, N-vinylcaprolactam, N-vinylmethylacetamide, acrylamide, acrylic acid, methacrylic acid, N-vinylmorpholine, hydroxyethyl methacrylate, diallyldimethylammonium chloride

(DADMAC) and/or [2-(methacryloyloxy)ethyl]trimethylammonium chloride (MAPTAC); polyalkylene glycols and/or alkyl polyglycols. Preference is especially given, as additives (g), to polyvinylpyrrolidones (e.g., Luviskol K15®, K20® and K30® from BASF), poly(N-vinylformamide)s, poly(N-vinylcaprolactam)s and copolymers of N-vinylpyrrolidone, N-vinylformamide and/or acrylic acid which can, also be partially or completely saponified.

The molecular weight of the additives (g) is preferably from 10² to 10⁷ g/mol, particularly preferably from 0.5×10⁴ to 10⁶ g/mol.

The amount of the polymer additive (g) used is, based on the total weight of the monomers to be polymerized in the copolymerization, preferably from 0.1 to 90% by weight, particularly preferably from 1 to 20% by weight and especially preferably from 1.5 to 10% by weight.

Use is especially made, as thickeners, of the thickeners of the Synergen® Y series from Clariant and in particular Synergen® Y 02 or Synergen® Y 04. These are AMPS-based copolymers as are described in WO 02/44230, reference to which is made herewith in its entirety.

The at least one thickener is present in each gel-form phase in an amount of preferably 0.001 to 10% by weight, particularly preferably of 0.01 to 5% by weight, very preferably of 0.02 to 1% by weight and in particular of 0.05 to 0.5% by weight and especially of 0.05 to 0.3% by weight, based on the total weight of the respective gel-form phase. The at least one thickener is present in the gel formulation in an amount of preferably 0.002 to 10% by weight, particularly preferably of 0.02 to 10% by weight, very preferably of 0.04 to 2% by weight and in particular of 0.1 to 1% by weight and especially of 0.1 to 0.6% by weight, based on the total weight of the gel formulation.

In addition to the incompatible substances A and B and the at least one thickener, the gel formulation according to the invention can comprise additional components. Suitable additional components depend on the nature and the end use of the gel formulation and are in principle known to a person skilled in the art.

Thus, the gel formulation, if a plant protection formulation is concerned, can comprise constituents standard for such systems. These include, for example, dispersing agents, antifoaming agents, preservatives, biocides, organic solvents, antifreeze agents and the like.

Suitable dispersing agents or surface-active agents are preferably nonionic. In principle, they can be of similar nature to the adjuvants described above, differing from them in a generally higher molecular weight. The higher molecular weights bring about, on the one hand, reduced dynamics of the dispersing agent molecules, which is why the adjuvant properties are only slightly expressed, and the high molecular weight brings about, on the other hand, a high affinity for interfaces, which can then be effectively stabilized by the dispersing agents. Suitable molecular weights for dispersing agents vary within the limits from approximately 1000 g/mol (e.g., phosphated tristyrylphenol ethoxylate, such as Soprophor 3D33 from Rhodia) up to several thousand g/mol in comb polymers (e.g., Atlox 4913 from Croda). In addition to the substance categories mentioned with the adjuvants, furthermore suitable as dispersants are alkylarylsulfonates, alkyl sulfates, alkylsulfonates, fatty alcohol sulfates, sulfated fatty alcohol glycol ethers, condensates of sulfonated naphthalene and sulfonated naphthalene derivatives with formaldehyde, condensates of naphthalene or naphthalenesulfonic acid with phenol and formaldehyde, lignosulfite waste liquors and methylcellulose. The dispersing agents are preferably present in those phases including a plant protection agent.

Antifoaming agents are preferably silicone-based antifoaming agents. The antifoaming agents are preferably present in all phases including a plant protection agent or an adjuvant.

A suitable preservative is, for example, dichlorophen. The preservatives are also preferably present in those phases including a plant protection agent or an adjuvant.

Suitable biocides are, for example, isothiazolinones, such as benzylisothiazolinone and methylisothiazolinone. The biocides are also preferably present in those phases including a plant protection agent or an adjuvant.

Suitable antifreeze agents are, for example, glycerol, ethylene glycol and propylene glycol. The antifreeze agents are preferably present in those phases including a plant protection agent.

Suitable organic solvents are, for example, aliphatic and in particular aromatic hydrocarbons, such as benzene, toluene, the xylenes, the Solvesso products or naphtha. The solvents are preferably present in those phases including an adjuvant.

A specific example of a gel formulation according to the invention is as follows:

1. Hydrogel (Phase A):

| | |
|---|---|
| Plant protection agent, e.g. fungicide, | 10-20 |
| for example dimoxystrobin: | parts by weight |
| Plant protection agent, e.g. fungicide, | 5-15 |
| for example epoxiconazole: | parts by weight |
| Dispersing agent, e.g. polyethylene | 1-5 |
| glycol/polypropylene glycol | parts by weight |
| block copolymer: | |
| Dispersing agent, e.g. tristyrylphenol | 2-5 |
| polyglycol ether: | parts by weight |
| Antifoaming agent, e.g. silicone emulsion: | 0.5-1 |
| | part by weight |
| Antifreeze agent, e.g. 1,2-propylene glycol: | 5-10 |
| | parts by weight |
| Biocide, e.g. benzylisothiazolin-2-one/ | 0.1-0.3 |
| methylisothiazolin-2-one: | part by weight |
| Thickener, e.g. Synergen Y 02 from Clariant: | 0.02-0.5 |
| | part by weight |
| Water: | to 100 |
| | parts by weight |

2. Hydrogel (Phase B):

| | |
|---|---|
| Adjuvant, e.g. C₁₆/C₁₈-alcohol + | 8-20 |
| 2-10 EO: | parts by weight |
| Solvent, e.g. aromatics mixture, | 5-12 |
| for example naphtha: | parts by weight |
| Thickener, e.g. Synergen Y 02 from | 0.02-0.5 |
| Clariant: | part by weight |
| Water: | to 100 |
| | parts by weight |

The gel formulation according to the invention can be converted back into the liquid state by electrolyte addition. Suitable electrolytes are organic and inorganic salts and in particular inorganic salts. Suitable inorganic salts are, for example, alkali metal halides, such as sodium chloride, sodium bromide, potassium chloride or potassium bromide, alkali metal sulfates, such as sodium sulfate or potassium sulfate, alkali metal nitrates, such as sodium nitrate and potassium nitrate, alkaline earth metal halides, such as calcium chloride or magnesium chloride, and alkaline earth metal sulfates, such as magnesium sulfate. Suitable organic salts are, for example, ammonium compounds, such as trimethylammonium chloride, tetramethylammonium chloride, triethylammonium chloride, tetraethylammonium chloride, triethanolammonium chloride and the like, acid addition salts of nitrogen-comprising heterocycles, such as pyridinium chloride, imidazolium chloride, pyrrolidinium chloride, piperidinium chloride and the like, carboxylic acid salts, such as sodium acetate, sodium triflate, sodium propionate and the like, or sulfonic acid salts and the like.

An additional subject matter of the invention is a process for the preparation of the gel formulation according to the invention including the following steps:
(i) preparation of a dimensionally stable gel including at least one substance A, a dispersing medium for the at least one substance A and at least one electrolyte-sensitive, preferably completely synthetic, thickener;
(ii) preparation of a dimensionally stable gel including at least one substance B, a dispersing medium for the at least one substance B and at least one electrolyte-sensitive, preferably completely synthetic, thickener;
(iii) optionally preparation of a dimensionally stable gel including at least one substance C, a dispersing medium for the at least one substance C and at least one electrolyte-sensitive, preferably completely synthetic, thickener, the at least one substance C being at least one of the substances A, at least one of the substances B or a substance other than these;
(iv) optionally one or more repetitions of step (iii); and
(v) arrangement in a container of the gels obtained in steps (i), (ii), optionally (iii) and optionally (iv).

For the case where the at least one substance A, the at least one substance B or the at least one substance C is insoluble in the dispersing medium, the preparation of the dimensionally stable gel in step (i), (ii) or (iii) is preferably carried out so that a dispersion, preferably a suspension, particularly preferably a suspension concentrate or a suspoemulsion, which includes the at least one substance A, B or C in the form of a dispersion (preferably suspension) in a liquid dispersing medium (preferably in an aqueous medium), is prepared, this is, if desired, brought to the desired particle size of the dispersed substance A, B or C, for example by milling in a suitable mill, e.g. colloid mill or stirrer mill (bead mill), and, subsequently, the dispersion obtained is treated with the at least one electrolyte-sensitive thickener in such an amount that the desired viscosity is achieved.

If the at least one substance A, the at least one substance B or the at least one substance C is soluble in the dispersing medium (this is described in this case accordingly as solvent), the preparation of the dimensionally stable gel in step (i), (ii) or (iii) preferably takes place so that a solution of the substance A, B or C in this solvent is prepared and the solution obtained is then treated with the at least one electrolyte-sensitive thickener in such an amount that the desired viscosity is achieved.

The arrangement of the individual gel phases depends on the form of the container in which the gel formulation according to the invention is to be stored and is in principle unrestricted. The type of the container is also in principle unrestricted. A specific example is the use of a multicomponent cartridge, such as is described in DE-A-102005021076.

With substances A and B, the diffusion of even the slightest amounts of which results in compatibility problems, it can be advantageous to physically separate the respective phases, for example by a separating wall or separating film, such as is produced, for example, in bags with several chambers, or by an additional gel layer free from active substance and/or adjuvant. Generally, however, this is not necessary and the phases present in the formulation are accordingly, in a preferred embodiment, not physically separated (i.e., by a separating wall, separating film, and the like).

An additional subject matter of the invention is the use of gel formulations according to the invention including at least one plant protection agent for combating plant pathogens and/or for combating undesirable plant growth.

The invention relates in addition to a method for combating plant pathogens and/or for combating undesirable plant growth comprising the following steps:
making available a gel formulation according to the invention including at least one plant protection agent;
adding at least one salt to the gel formulation to produce a liquid formulation;
diluting the liquid formulation with water to produce an aqueous spray slurry; and
applying the spray slurry to plants or plant parts.

Reference is made to the above statements with regard to suitable and preferred plant protection agents and salts. Suitable plant pathogens and undesirable plant growth to be combated depend on the individual plant protection agent. Target pathogens and target plants in connection with the plant protection agents used to combat them are known in each case to a person skilled in the art.

It is possible, through the gel formulation according to the invention, to avoid or at least to reduce the incompatibility problems of substances when formulated together. Accordingly, it is now possible to formulate together substances which hitherto could be formulated either completely separately or could be formulated together in only limited amounts. Thus, for example, with plant protection formulations, incompatible active substances or incompatible active substance/adjuvant combinations can be formulated together. In addition, adjuvants can be used in a very high concentration, which can significantly increase the effectiveness of the plant protection agent. The conversion into a flowable state which can be metered and is accordingly ready for use takes place in a simple way through electrolyte addition.

The invention is now illustrated by the following nonlimiting examples.

### EXAMPLES

1. Preparation of a Gel Formulation According to the Invention

| No. | Component | Amount | |
|---|---|---|---|
| 1 | Dimoxystrobin | 133 | g |
| 2 | Epoxiconazole | 50 | g |
| 3 | Solvent (aromatics mixture; naphtha) | 89 | g |
| 4 | Adjuvant (C₁₆/C₁₈-alcohol + 2-10 EO) | 133 | g |
| 5 | Dispersing agent I (polyethylene glycol/ | 20 | g |
| | polypropylene glycol block copolymer) | | |
| 6 | Dispersing agent II (tristryrylphenol polyglycol ether) | 40 | g |
| 7 | Antifoaming agent (based on silicone) | 2 | g |
| 8 | Antifreeze agent (1,2-propylene glycol) | 100 | g |
| 9 | Thickener (Synergen ® Y 02 from Clariant) | 2 | g |
| 10 | Biocide (benzylisothiazolin-2-one/ | 0.1 | g |
| | methylisothiazolin-2-one) | | |
| 11 | Water | to 1 | liter |

A suspension was prepared from the components Nos. 1, 2, 5, 6, 7, 8, 10 and 11 (water in an amount of 200 g) and then milled using a bead mill (particle size: 70% <2 μm). 2 g of the thickener were then stirred in and a gel (gel 1) was obtained with a viscosity of >5000 mPa·s.

2 g of thickener were added to 190 g of water to produce a highly viscous gel. Adjuvant 4 dissolved in solvent 3 was then stirred into this gel and gel 2 was obtained. Gel 1 was first introduced into three glass containers and then covered with a layer of gel 2, and then the particle size was analyzed (sample 0). A glass container was stored at ambient temperature (sample 1), one at 40° C. (sample 2) and one at 50° C. (sample 3). After two weeks, all three samples were stored at ambient temperature for one day and subsequently analyzed for crystal formation. The results are given in the following table.

| | Proportion of | | |
|---|---|---|---|
| | particles <2 μm | d50 | d90 |
| Sample | [%] | [μm] | [μm] |
| Sample 0 | 72.0 | 1.4 | 3.0 |
| Sample 1 | 72.0 | 1.4 | 3.0 |
| Sample 2 | 72.0 | 1.4 | 3.1 |
| Sample 3 | 68.0 | 1.5 | 3.4 |

As the results show, essentially no crystal growth occurs, even at higher storage temperatures.

2. Preparation of a Monophase Gel Formulation (Comparison)

| No. | Component | Amount | |
|---|---|---|---|
| 1 | Dimoxystrobin | 133 | g |
| 2 | Epoxiconazole | 50 | g |
| 3 | Solvent (aromatics mixture; naphtha) | 89 | g |
| 4 | Adjuvant (C₁₆/C₁₈-alcohol + 2-10 EO) | 133 | g |
| 5 | Dispersing agent I (polyethylene glycol/ | 20 | g |
| | polypropylene glycol block copolymer) | | |
| 6 | Dispersing agent II (tristryrylphenol polyglycol ether) | 40 | g |
| 7 | Antifoaming agent (based on silicone) | 2 | g |
| 8 | Antifreeze agent (1,2-propylene glycol) | 100 | g |
| 9 | Thickener (xanthan) | 2 | g |
| 10 | Biocide (benzylisothiazolin-2-one/ | 0.1 | g |
| | methylisothiazolin-2-one) | | |
| 11 | Water | 490 | g |

A suspension was prepared from the components Nos. 1, 2, 5, 6, 7, 8, 10 and 11 (water in an amount of 390 g) and then milled using a bead mill (particle size: 70% <2 μm). Adjuvant 4 dissolved in solvent 3 was then incorporated in the suspension via a rotor/stator mill and the mixture was treated with thickener and water (100 g).

The gel obtained was introduced into three glass containers and then the particle size was analyzed (sample 0). A glass container was stored at ambient temperature (sample 1), one at 40° C. (sample 2) and one at 50° C. (sample 3). After two weeks, all three samples were stored at ambient temperature for one day and subsequently analyzed for crystal formation. The results are given in the following table.

| | Proportion of | | |
|---|---|---|---|
| | particles <2 μm | d50 | d90 |
| Sample | [%] | [μm] | [μm] |
| Sample 0 | 82.5 | 1.3 | 2.3 |
| Sample 1 | 58.7 | 1.8 | 3.6 |
| Sample 2 | 53.8 | 1.9 | 6.8 |
| Sample 3 | 46.9 | 2.1 | 11.9 |

As the results show, a significant crystal growth takes place.

3. Preparation of a Monophase Gel Formulation (Comparison)

| No. | Component | Amount | |
|---|---|---|---|
| 1 | Dimoxystrobin | 133 | g |
| 2 | Epoxiconazole | 50 | g |
| 3 | Solvent (aromatics mixture; naphtha) | 89 | g |
| 4 | Adjuvant (C₁₆/C₁₈-alcohol + 2-10 EO) | 133 | g |
| 5 | Dispersing agent I (polyethylene glycol/ | 20 | g |
| | polypropylene glycol block copolymer) | | |
| 6 | Dispersing agent II (tristryrylphenol polyglycol ether) | 40 | g |
| 7 | Antifoaming agent (based on silicone) | 2 | g |
| 8 | Antifreeze agent (1,2-propylene glycol) | 100 | g |
| 9 | Thickener (Synergen ® Y 02 from Clariant) | 2 | g |
| 10 | Biocide (benzylisothiazolin-2-one/ | 0.1 | g |
| | methylisothiazolin-2-one) | | |
| 11 | Water | to 1 | liter |

A suspension was prepared from the components Nos. 1, 2, 5, 6, 7, 8, 10 and 11 (water in an amount of 390 g) and then milled using a bead mill (particle size: 70% <2 μm). Adjuvant 4 dissolved in solvent 3 was then incorporated in the suspension via a rotor/stator mill and the mixture was treated with thickener and water (100 g).

The gel obtained was introduced into three glass containers and then the particle size was analyzed (sample 0). A glass container was stored at ambient temperature (sample 1), one at 40° C. (sample 2) and one at 50° C. (sample 3). After two weeks, all three samples were stored at ambient temperature for one day and subsequently analyzed for crystal formation. The results are given in the following table.

| | Proportion of | | |
|---|---|---|---|
| | particles <2 μm | d50 | d90 |
| Sample | [%] | [μm] | [μm] |
| Sample 0 | 86.0 | 1.1 | 2.2 |
| Sample 1 | 67.0 | 1.3 | 7.5 |
| Sample 2 | 46.0 | 2.5 | 13.8 |
| Sample 3 | 35.5 | 5.0 | 22.0 |

1-16. (canceled)

17. A storage-stable gel formulation, including at least two essentially unmixed hydrogels, comprising in each hydrogel at least one electrolyte-sensitive, completely synthetic, thickener and further comprising in one of the hydrogels (phase A) one or more substances A and in an additional hydrogel (phase B) one or more substances B, at least one of the substances A being incompatible with at least one of the substances B in the amounts respectively present in respective hydrogels in the gel formulation.

18. The gel formulation of claim 17, wherein at least one of the substances A and/or at least one of the substances B is sparingly soluble in water.

19. The gel formulation of claim 17, wherein at least one of the substances A promotes the precipitation of at least one of the substances B in an aqueous dispersion comprising from 5 to 100% by weight of water and/or at least one of the substances B promotes the precipitation of at least one of the substances A in an aqueous dispersion comprising from 5 to 100% by weight of water.

20. The gel formulation of claim 17, wherein at least one of the substances A promotes the crystal growth or Ostwald ripening of at least one of the substances B in an aqueous dispersion comprising from 5 to 100% by weight of water and/or at least one of the substances B promotes the crystal growth or Ostwald ripening of at least one of the substances A in an aqueous dispersion comprising from 5 to 100% by weight of water.

21. The gel formulation of claim 20, wherein at least one of the substances A increases the solubility in water of at least one of the substances B and/or at least one of the substances B increases the solubility in water of at least one of the substances A.

22. The gel formulation of claim 17, wherein the at least two hydrogels each has a viscosity of at least 1000 mPa·s.

23. The gel formulation of claim 17, wherein the at least two hydrogels have at least one common interface.

24. The gel formulation of claim 17, wherein the at least one electrolyte-sensitive, completely synthetic, thickener is selected from the group consisting of polyacrylic acid and/or a polyacrylate with a number-average molecular weight of 1×10³ to 1×10⁹, homo- or copolymer of acrylamide and/or methacrylamide with a number-average molecular weight of 1×10³ to 1×10⁹ and an ethylene/maleic anhydride copolymer with a number-average molecular weight of 1×10³ to 1×10⁹.

25. The gel formulation of claim 24, wherein the at least one electrolyte-sensitive, completely synthetic, thickener is selected from homo- or copolymers of acrylamide and/or methacrylamide with a number-average molecular weight of 1×10³ to 1×10⁹.

26. The gel formulation of claim 25, wherein the at least one electrolyte-sensitive, completely synthetic, thickener is selected from copolymers based on 2-acrylamido-2-methyl-1-propanesulfonic acid and macromonomers.

27. The gel formulation of claim 25, wherein the at least one electrolyte-sensitive, completely synthetic, thickener is selected from copolymers of
(a) 2-acrylamido-2-methyl-1-propanesulfonic acid and/or a salt thereof with
(b) at least one olefinically unsaturated, noncationic, optionally crosslinking and optionally heat-sensitive co-monomer exhibiting at least one oxygen, nitrogen, sulfur or phosphorus atom and having a molecular weight of at most 500; and/or
(c) at least one olefinically unsaturated cationic co-monomer exhibiting at least one oxygen, nitrogen, sulfur or phosphorus atom and having a molecular weight of at most 500; and/or
(d) at least one olefinically unsaturated silicon-comprising co-monomer; and/or
(e) at least one olefinically unsaturated fluorine-comprising co-monomer; and/or
(f) at least one optionally heat-sensitive macromer having a number-average molecular weight of at least 200; and/or
(g) at least one polymer additive with a number-average molecular weight of 200 to 1×10⁹.

28. The gel formulation of claim 17, wherein phase A comprises at least one plant protection agent which is essentially insoluble in water and optionally at least one dispersing agent.

29. The gel formulation of claim 28, wherein phase B comprises a plant protection agent which is different from the plant protection agent of phase A and/or an adjuvant.

30. A process for the preparation of the gel formulation of claim 17, further comprising:
(i) preparing a dimensionally stable gel including at least one substance A, a dispersing medium for the at least one substance A and at least one electrolyte-sensitive, completely synthetic, thickener;
(ii) preparing a dimensionally stable gel including at least one substance B, a dispersing medium for the at least one substance B and at least one electrolyte-sensitive, completely synthetic, thickener;
(iii) optionally preparing a dimensionally stable gel including at least one substance C, a dispersing medium for the at least one substance C and at least one electrolyte-sensitive, completely synthetic, thickener, the at least one substance C being at least one of the substances A, at least one of the substances B or a substance other than these;
(iv) optionally repeating step (iii); and
(v) arranging in a container the gels obtained in steps (i), (ii), optionally (iii) and optionally (iv).

31. A method for combating plant pathogens and/or for combating undesirable plant growth comprising:
(i) making available the gel formulation of claim 28;
(ii) adding at least one salt to the gel formulation to produce a liquid formulation;
(iii) diluting the liquid formulation with water to produce an aqueous spray slurry; and
(iv) applying the spray slurry to plants or plant parts.

32. The method of claim 31, wherein phase B comprises a plant protection agent which is different from the plant protection agent of phase A and/or an adjuvant.

33. The method of claim 32, wherein the at least two hydrogels each has a viscosity of at least 1000 mPa·s.

34. The method of claim 32, wherein the at least two hydrogels have at least one common interface.

35. The method of claim 32, wherein the at least one electrolyte-sensitive, completely synthetic, thickener is selected from the group consisting of polyacrylic acid and/or a polyacrylate with a number-average molecular weight of 1×10³ to 1×10⁹, homo- or copolymer of acrylamide and/or methacrylamide with a number-average molecular weight of 1×10³ to 1×10⁹ and an ethylene/maleic anhydride copolymer with a number-average molecular weight of 1×10³ to 1×10⁹.

36. The method of claim 35, wherein the at least one electrolyte-sensitive, completely synthetic, thickener is selected from homo- or copolymers of acrylamide and/or methacrylamide with a number-average molecular weight of 1×10³ to 1×10⁹.

37. The method of claim 36, wherein the at least one electrolyte-sensitive, completely synthetic, thickener is selected from copolymers based on 2-acrylamido-2-methyl-1-propanesulfonic acid and macromonomers.
